(19) United States
(12) Patent Application Publication
(10) Pub. No.: US 2022/0306898 A1
(43) Pub. Date: Sep. 29, 2022

(54) SILICON-BASED COMPOSITIONS AND APPLICATIONS THEREOF

(71) Applicant: Momentive Performance Materials Inc., Waterford, NY (US)

(72) Inventors: Kartick Bindumadhavan, Bengaluru (IN); Diao Cheng, White Plains, NY (US); Debanga Bhusan Konwar, Benaluru (IN); Monjit Phukan, West Harrison, NY (US); Murali Mg, Karnataka (IN); Raghavendra Hebbar, Bangalore (IN); Praveen Mishar, Bangalore (IN); Karthik Sivasubramanian, Bangalore (IN)

(21) Appl. No.: 17/690,104

(22) Filed: Mar. 9, 2022

Related U.S. Application Data
(60) Provisional application No. 63/158,437, filed on Mar. 9, 2021.

(51) Int. Cl. C09D 183/08; C08G 77/24; C08G 77/46; C09D 183/12; H01M 50/449; H01M 4/62

(52) U.S. Cl. CPC C09D 183/08; C08G 77/24; C08G 77/46; C09D 183/12; H01M 50/449; H01M 4/623; C08G 77/80

(57) ABSTRACT

The present technology provides a surface modifying composition comprising a silicone based, surface modifying agent suitable for use as part of a component of an electrochemical cell. The compositions can be employed as a coating for a separator, a coating for an electrode active material, and/or as part of an electrode slurry to form an electrode, e.g., an anode, of an electrochemical cell.

### CROSS-REFERENCE TO RELATED APPLICATIONS

This application claims priority to and the benefit of U.S. Provisional Application No. 63/158,437 filed on Mar. 9, 2021, the disclosure of which is incorporated herein by reference in its entirety.

### FIELD

The present technology relates to surface modifying compositions. In particular, the present technology relates to a surface modifying composition comprising silicon-based surface modifying agents, and the use of such compositions as a component or as part of a component in energy generation and storage devices such as, for example, batteries.

### BACKGROUND

The growing demand of high-performance rechargeable devices has led to increased focus on the development of robust materials and components employed in energy generation and storage devices. The output performance of energy devices is influenced by individual components of the device. For example, the life cycle and efficiency of electrodes in rechargeable batteries are influenced by active materials, binding agents, and current collectors. In this regard, binding agents play a key role in maintaining the life cycle and influence the capacity and impedance of devices. Binding agents and adhesives such as carboxy methyl cellulose (CMC), styrene butadiene rubber (SBR), polyvinylidene fluoride (PVDF), polymethylmethacrylate (PMMA), and polyethylene glycol (PEG) are well known materials that have been used as binding agents in rechargeable devices for the fabrication of electrodes. Some of these adhesives/binding agents are hydrophilic or hydrophobic in nature. In the electrochemical cells of the rechargeable devices, binding agents or adhesives are used in the active material slurry to help maintain the adherence of active material on the surface of the current collector. During the electrochemical processes, the electrode active material undergoes intercalation and deintercalation of alkali metal ions causing volume changes in the structure of the active material. The binding agent desirably serves to maintain the structural stability of the electrode and absorbs mechanical stress during electrochemical functioning of the active material. As such, polymeric materials with long backbone structures that can maintain their flexibility are useful as binding agents. However, many conventional binding agents cannot meet the technical requirements that are and will be required in secondary batteries such as, for example, changes in electrolyte material, active material, voltage, and operation temperature, and compatibility with non-toxic solvents for slurry preparation and processability, etc.

To enhance the adhesive strength among the particles and the binding agent, surface modification of the particles or the binding agents is often required. Surface modifying agents have also been utilized to improve the interaction and compatibility between the binding agent and the separator membranes. The particles, such as electrode active materials and ceramic particles used in separator coatings often require surface modification to enhance their compatibility in the overall formulation. For example, electrode active materials may need surface modifying agents, such as silanes, to enhance the adhesive strength among the electrode active materials and the binding agent. Another example of using silane coupling agents as surface modifying agents for ceramic particles to improve the interaction and compatibility between ceramic particles and polyolefin separator membranes.

Apart from the binding agent material employed in batteries, separators also play a vital role in maintaining the performance and safety of the battery. A separator is a porous polymer membrane placed between the two electrodes in the electrochemical cell to prevent a short circuit while allowing the flow of ions in the system. Some conventional separator materials for batteries include cellulosic papers, cellophane, nonwoven fabrics, foams, ion exchange membranes, and microporous flat sheet membranes made from polymeric materials. Polyolefins are the most prevalent separator materials used in many commercially available secondary batteries. Polyethylene (PE) and polypropylene (PP) are among the most commonly used separators of the polyolefins class of materials. Polyolefinic separators, however, show challenges in maintaining dimensional stability at elevated temperatures, mechanical strength, and processability. Heating at extreme temperatures is detrimental for the safe operation of batteries, and the conventional separators, such as polyolefin materials, have a relatively low melting point. Therefore, a heat resistant separator material is desired to ensure safety of the battery operation in high heat environment. For instance, a PE separator typically melts around 135° C., and a PP separator melts around 160° C. Abnormal heating of the battery, which can be caused due to excess load or improper fabrication leads to physical deformation of the separator membrane that can cause a short circuit between the anode and the cathode. The temperature at which the separator melts and leads to the short circuit is often referred to as Melt-Down temperature. A violent heat generation or an explosion may also occur if the battery is exposed to an even higher temperature. Additionally, in a lithium ion battery, the lithium dendrite growth has been shown to rupture the separator leading to the short circuit. Therefore, a separator that provides better thermal resistance and mechanical integrity is becoming more important factor contributing to the safety of the battery.

Another important facet of the separator in the battery is the interface with the electrode. The resistance at the interface affects the mobility of the ions, which subsequently affects the cycle efficiency, output, and capacity characteristics of the battery.

Therefore, there is a need for a composition that addresses the above issues.

### SUMMARY

Provided is a surface modifying composition comprising a surface modifying agent that can be employed for an electrochemical cell such as, for example, a battery.

In one embodiment, provided is a surface modifying composition comprising one or more surface modifying agents represented by Formula 1:

(R)ₐ(W)_{b}(R)_{a″} Formula 1

wherein a, a″ or b is zero or an integer greater than zero, with the proviso that (a+a″+b) is always greater than 0,
R is represented by Formula (1a) which is linear or branched:

(CH₂)_{c}(CH₂O)_{d}(CHOH)ₑ(X)_{g} Formula (1a)

X is independently a group represented by Formula (1b):

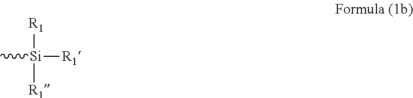

where R₁, R₁′, and R₁″ are each independently a hydrogen or C₁-C₂₀ alkyl radical, C₁-C₂₀ alkoxy radical, a C₆-C₂₀ aromatic radical, a hydroxyl radical, a hydrogen radical, a C₁-C₂₀ unsubstituted or substituted hydrocarbon, a C₁-C₂₀ fluorinated hydrocarbon, an ether, a fluoroether, an alkylene, a cycloalkylene, an arylene alkylene, a monovalent cyclic or acyclic, a methacrylate, a substituted or un-substituted carboxylate radical or epoxy radical, a C₁-C₁₀ carbonate or carbonate ester, c, d, e, and g are each independently zero or an integer greater than zero with the proviso that c+d+e+g>0,
W is a group represented by Formula (1c)

(Y)ₕ(Z)ᵢ Formula (1c)

wherein h and i are each independently zero or an integer greater than zero with the proviso that h+i>0,
Y in formula (1c) is a group represented by Formula (1d):

(M₁)_{x″}(D₁)ⱼ(D₂)ₖ((T₁)_{m′}(Q₁)_{n′}(M₂)_{y″} Formula (1d)

wherein j, k, l, m′, n′, x″, and y″ are each independently zero or an integer greater than zero with the proviso that (j+k+m′+n′+x″+y″)>0.
wherein M₁ is a group represented by Formula (1e):

R₂R₃R₄SiI_{1/2} Formula (1e)

D₁ is a group represented by Formula (1f):

R₅R₆SiI_{2/2} Formula (1f)

D₂ is a group represented by Formula (1g):

R₇R₈SiI_{2/2} Formula (1g)

T₁ is a group represented by Formula (1h):

R₉SiI_{3/2} Formula (1h)

Q₁ is a group represented by Formula (1i):

SiI_{4/2} Formula (1i)

M₂ is a group represented by Formula (1j):

R₁₀R₁₁R₁₂SiI_{1/2} Formula (1j)

R₂-R₁₂ are each independently R, R₁, R_{1′}, or R_{1″},
I is O or a CH₂ group with the proviso that the molecule contains an even number of O_{1/2} and even number of (CH₂)_{1/2},
Z in Formula (1c) is independently urethane, urea, anhydride, amide, imide, hydrogen radical, or a monovalent cyclic or acyclic, aliphatic or aromatic, substituted or un-substituted hydrocarbon, or a fluorinated hydrocarbon having 1-20 carbon atoms;
wherein the surface modifying agents, when in contact with a surface of an electrochemical substrate, modify the surface of the substrate.

In one embodiment, the composition comprises two parts, a first part, wherein W of the formula 1 is represented by the formula:

(Y₁)ₕ(Z₁)ᵢ Formula (1k); and

a second part, wherein W of the formula 1 is represented by the formula:

(Y₂)ₕ(Z₂)ᵢ Formula (1l)

wherein Y₁ is represented by

(M₁)_{x″}(D₁)ⱼ(D₂)ₖ(M₂)_{y″} (1k′)

wherein M₁ is R₂R₃R₄SiI_{1/2};
D₁ is R₅R₆SiI_{2/2};
D₂ is R₇R₈SiI_{2/2}; and
M₂ is R₁₀R₁₁R₁₂SiI_{1/2};
where R₂ and R₁₂ are each independently selected from an alkene radical; R₃-R₈ and R₁₀-R₁₁ are each independently selected from a C1-C20 alkyl radical; a C1-C20 substituted or unsubstituted hydrocarbon; and
wherein Y₂ is represented by

(M₁)_{x″}(D₁)ⱼ(D₂)ₖ(M₂)_{y″} (1l′)

where M₁ is R₂R₃R₄SiI_{1/2};
D₁ is R₅R₆SiI_{2/2};
D₂ is R₇R₈SiI_{2/2}; and
M₂ is R₁₀R₁₁R₁₂SiI_{1/2};
wherein R₂, R₃, R₄, R₅, R₆, R₇, R₈, R₁₀, R₁₁, R₁₂ are each independently selected from C1-C20 alkyl radical, substituted alkyl radical, or hydrogen;
wherein at least one of R₂-R₈ and R₁₁-R₁₂ groups is hydrogen; and Z₁ and Z₂ are independently selected from Z.

In one embodiment, the R₂ and R₁₂ are in terminal positions and are each independently a C1-C20 alkene radical containing a fluorine atom.

In one embodiment, Y₁ is represented by:

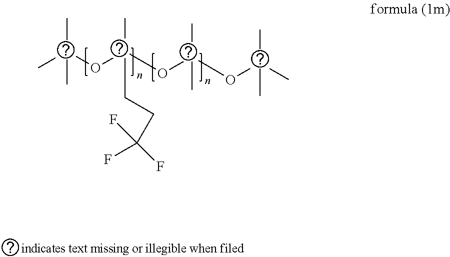

wherein n is an integer in the range from 1 to 1000.

In one embodiment, the Y₂ is represented by:

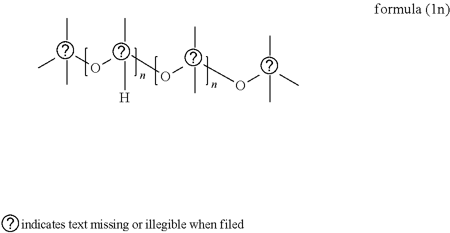

wherein n is an integer in the range from 1 to 1000.

In one embodiment, R₂ and R₁₂ are in terminal positions and are each C1-C20 carbonate.

In one embodiment, the surface modifying agent is represented by:

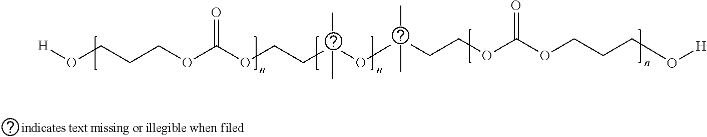

where n is an integer in the range from 1 to 1000.

In one embodiment, W of formula 1 is represented by:

(M₁)_{x″} Formula (1d′)

wherein x″>0, and
wherein M₁ is a group represented by Formula (1e):

R₂R₃R₄SiI_{1/2} Formula (1e)

where one or more of the R₂-R₄ groups is a polyalkylene oxide functional group;
where I is O with the proviso that the molecule contains an even number of O_{1/2}.

In one embodiment, one or more of R₂ to R₁₂ of M₁, M₂, D₁ D₂, or T is a polyalkylene oxide group.

In one embodiment, the surface modifying agent is represented by formula:

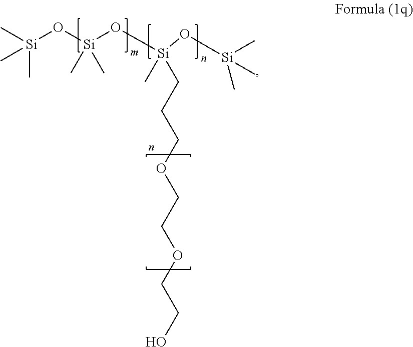

where m, n are integers in the range from 1 to 500.

In one embodiment, Z of formula (1c) is a urethane.

In one embodiment, Y of formula (1c) is a siloxane represented by:

(T₁)ₘ Formula (1d″)

wherein m is 1 or an integer greater than 1, and T₁ is a group represented by Formula (1h):

R₉SiI_{3/2} Formula (1h)

where R₉ is R, R₁, R_{1′}, or R_{1″}, and
where I is O, with the proviso that the molecule contains an even number of O_{1/2}.

In one embodiment, R₉ is C₁-C₂₀ alkoxy radical, a C₁-C₂₀ alkyl radical, or a combination thereof.

In one embodiment, R₉ is an ether group —O—(CH₂)_{b′}CH₃ where b′ is 0-10.

In one embodiment, the surface modifying agent has a ladder configuration, or a cage configuration.

In one embodiment, the surface modifying agent has a ladder configuration represented by:

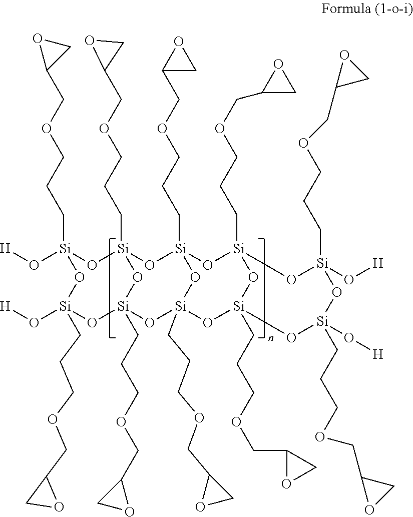

where n is an integer in the range from 1 to 500;

a ladder configuration represented by:

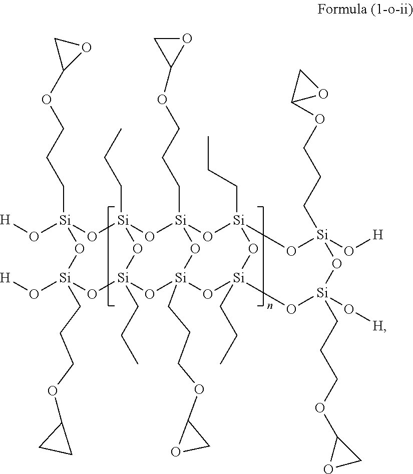

where n is an integer in the range from 1 to 500;

a ladder configuration represented by:

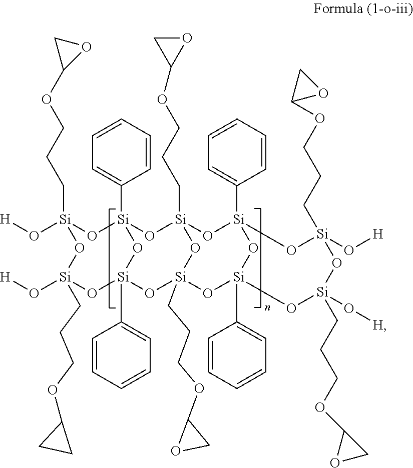

where n is an integer in the range from 1 to 500;

a ladder configuration represented by:

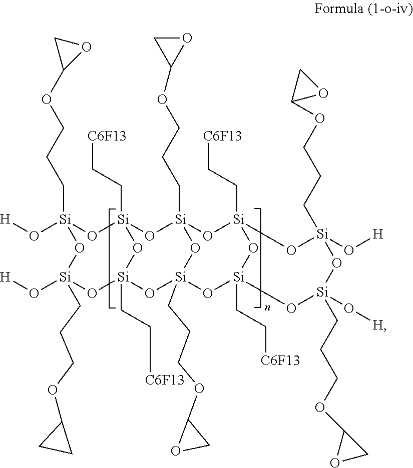

where n is an integer in the range from 1 to 500.

a ladder configuration represented by:

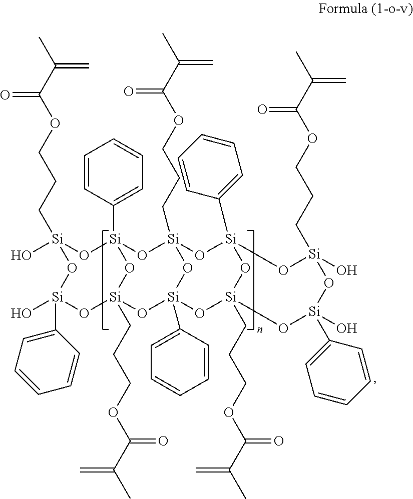

where n is an integer in the range from 1 to 500;

a ladder configuration represented by:

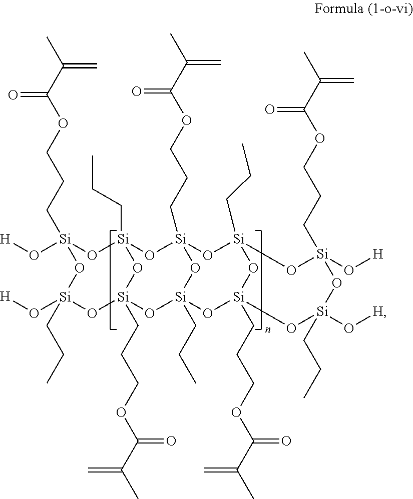

where n is an integer in the range from 1 to 500.

a ladder configuration represented by:

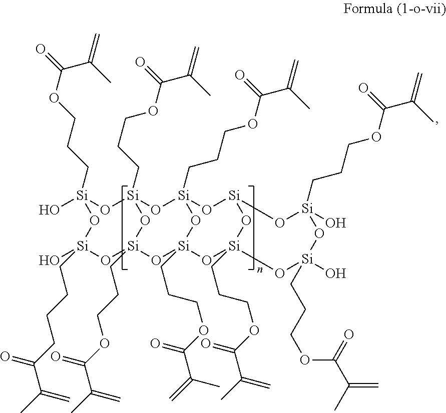

where n is an integer in the range from 1 to 500;
a ladder configuration represented by:

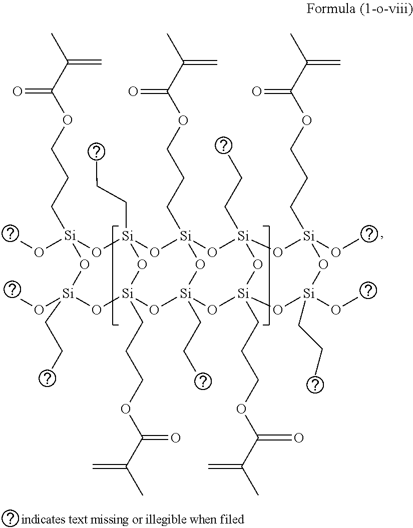

where n is an integer in the range from 1 to 500;

a ladder configuration represented by:

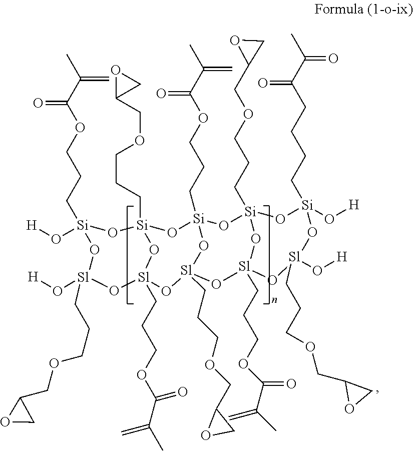

where n is an integer in the range from 1 to 500; and/or

a cage configuration represented by:

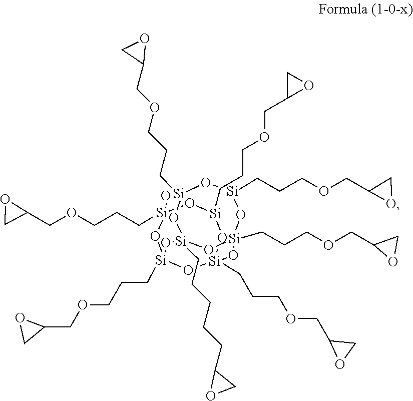

where n is an integer in the range from 1 to 500.

In one embodiment according to any of the previous embodiments, the surface modifying agent is present in an amount from about 0.1 wt. % to about 10 wt. %,

In one embodiment, a is 1 when a″ is 0; or a is 0 when a″ is 1 with the proviso that b is 0, the surface modifying agent is represented by:

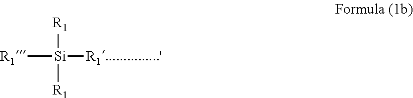

where R₁, R₁′, R₁″, and R₁″′ are each independently a hydrogen or a C₁-C₂₀ alkyl radical, a C₁-C₂₀ alkoxy radical, a C₆-C₂₀ aromatic radical, a hydroxyl radical, a hydrogen radical, a C₁-C₂₀ unsubstituted or substituted hydrocarbon, a C₁-C₂₀ fluorinated hydrocarbon, an ether, a fluoroether, an alkylene, a cycloalkylene, an arylene alkylene, a monovalent cyclic or acyclic, a methacrylate, a substituted or un-substituted carboxylate radical or epoxy radical, a C₁-C₁₀ carbonate or carbonate ester.

In one embodiment according to any of the previous embodiments, the electrochemical substrate is an electrode, a separator, a binding agent, an electrode active material, or a combination thereof.

In one embodiment according to any of the previous embodiments, the surface modifying agent modifies the surface of the substrate by formation of a film.

In one embodiment according to any of the previous embodiments, the surface modifying agent modifies the surface of the substrate by formation of a coating.

In one embodiment according to any of the previous embodiments, the surface modifying agent modifies the surface of the substrate by binding particles to the substrate.

In one embodiment according to any of the previous embodiments, the electrochemical substrate is disposed in a non-aqueous secondary battery.

In one aspect, provided is a coated electrochemical substrate comprising the surface modifying agent according to any of the previous embodiments.

In one embodiment, the substrate has a shrinkage of less than about 10%. when heated at a temperature of 200° C. for 3 min.

In one embodiment, the substrate has an electrolyte uptake of more than 100% at a temperature of 25° C. with reference to the uncoated polypropylene substrate.

In another aspect, provided are particulate-aggregates comprising the surface modifying agent according to any of the previous embodiments.

In one embodiment, the electrode particulate-aggregates have a retention of specific capacity of at least 38% after 500 cycles and at a current density of 100 mA/g.

In one aspect, provided is a process for preparing a surface modifying composition, the process comprising: contacting the one or more surface modifying agents according to any of the previous embodiments with a solvent to prepare a slurry.

In one aspect, provided is a process for preparing a surface-modified electrochemical substrate, the process comprising contacting the composition according to any of the previous embodiments to an electrochemical substrate.

In one aspect, provided is a surface modified electrochemical substrate prepared by the process.

In one aspect, provided is an electrochemical cell comprising the surface modified electrochemical substrate.

In one embodiment, the surface modified electrochemical substrate is an electrode and/or a electrochemical separator.

In another aspect, provided is the use of a surface modifying composition of any of the previous embodiments as a binding agent in an electrode for an electrochemical cell.

In another aspect, provided is the use of a surface modifying composition of any of the previous embodiments as a as a coating for an electrochemical substrate.

In one aspect, provide is a process for preparing a surface modifying composition, the process comprising: contacting the one or more surface modifying agents with a solvent to prepare a slurry, wherein the one or more surface modifying agents is represented by Formula 1 as described above and throughout the specification.

In another aspect, provided is a process for preparing a surface-modified electrochemical substrate comprising contacting the surface modifying composition according to any of the previous embodiments to an electrochemical substrate.

In still another aspect, provided is a surface modified electrochemical substrate prepared by the foregoing process.

In yet another aspect, provided is an electrochemical sell comprising the surface modified electrochemical substrate.

In one aspect, provided is an electrochemical cell having one or more components comprising the surface modifying composition comprising the one or more surface modifying agent represented by Formula 1.

In one embodiment, the electrochemical cell comprises a separator, where the separator comprises a polymeric substrate having a coating disposed on a surface thereof, where the coating is the surface modifying composition comprising the one or more surface modifying agents represented by Formula 1.

In one embodiment, the electrochemical cell comprises an electrode material comprising a binding agent, where the binding agent comprises the surface modifying composition comprising the one or more surface modifying agents represented by Formula 1.

In another embodiment, provided is a process for preparing a surface-modified electrochemical substrate, the process comprising applying the surface modifying composition comprising the one or more surface modifying agents represented by Formula (1) to an electrochemical substrate.

In yet another embodiment, provided is a surface modified electrochemical substrate prepared by the foregoing process of applying the surface modifying composition comprising one or more surface modifying agent represented by Formula (1) to an electrochemical substrate.

In yet another embodiment, provided is an electrochemical cell comprising the surface modified electrochemical substrate, wherein the surface is modified by applying the surface modifying composition comprising the one or more surface modifying agents represented by Formula (1) to the electrochemical substrate.

In still yet a further aspect, provided is an electrochemical cell comprising (i) an anode, (ii) a cathode, (iii) a separator, and (iv) an electrolyte, wherein the anode, cathode, and/or separator comprises the surface modifying composition.

These and other embodiments and aspects are further understood with reference to the following detailed description.

### BRIEF DESCRIPTION OF THE DRAWINGS

FIG. 1A is a graph showing cyclic stability of siloxane formulation coated separator.

FIG. 1B is a graph showing cyclic stability of an uncoated separator and a siloxane formulation coated separator;

FIG. 2 is a cyclic voltammogram of graphite electrode in presence of a siloxane binding agent;

FIG. 3 is a graph showing cyclic stability of an electrochemical cell with PVDF as a binding agent, and siloxane as a binding agent.

FIG. 4. is a cyclic voltammogram of a coin cell comprising silylated polyurethane (SPUR) as binding agent using silicon carbide containing anode.

FIG. 5. is a cyclic voltammogram of a coin cell with silylated polyurethane (SPUR) as binding agent using anode comprising graphite, silicon monoxide and carbon black.

FIG. 6. is a cyclic v voltammogram of the anode formulation comprising graphite, silicon monoxide, carbon black, SBR, and CMC as a binding agent.

FIG. 7. is a cyclic voltammogram of the anode formulation comprising graphite, silicon monoxide, carbon black, SBR, and trisiloxane polyether (Silwet 408) as a binding agent.

FIG. 8. is a galvanostatic charge discharge data of selected cycles of benchmark and trisiloxane polyether (Silwet 408) modified electrodes.

FIG. 9A: is a SEM image for the electrode particles without treatment with surface modifying agent (no aggregate formed). FIG. 9B is a SEM image of displaced particulate aggregates that comprise surface modifying agents of the present invention.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” is not to be limited to the precise value specified. In some instances, the approximating language may correspond to the precision of an instrument for measuring the value.

As used herein, the term “aromatic” and “aromatic radical” are used interchangeably and refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly, a tetrahydronaphthyl radical is an aromatic radical comprising an aromatic group (C₆H₃) fused to a nonaromatic component —(CH₂)₄—. For convenience, the term “aromatic radical” or “aromatic” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C7 aromatic radical comprising a methyl group, the methyl group being a functional group which is an alkyl group. Similarly, the 2-nitrophenyl group is a C6 aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphen-1-yl, 4-vinylphen-1-yl, vinylidenebis(phenyl), and the like. The term “a C3-C10 aromatic radical” includes aromatic radicals containing at least three but no more than 10 carbon atoms. The aromatic radical 1-imidazolyl (C₃H₂N₂—) represents a C3 aromatic radical. The benzyl radical (C₇H₇—) represents a C7 aromatic radical. In one or more embodiments, the aromatic groups may include C6-C30 aromatic groups, C10-C30 aromatic groups, C15-C30 aromatic groups, C20-C30 aromatic groups. In some specific embodiments, the aromatic groups may include C3-C10 aromatic groups, C5-C10 aromatic groups, or C8-C10 aromatic groups.

As used herein, the term “cycloaliphatic group” and “cycloaliphatic radical” may be used interchangeably and refers to a radical having a valence of at least one, and wherein the radical comprises an array of atoms that is cyclic but not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C6 cycloaliphatic radical comprising a methyl group, the methyl group being a functional group which is an alkyl group. Similarly, the 2-nitrocyclobut-1-yl radical is a C4 cycloaliphatic radical comprising a nitro group, the nitro group being a functional group. A cycloaliphatic radical may comprise one or more halogen atoms which may be the same or different. Halogen atoms include, for example, fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis(cyclohex-4-yl) (i.e., —C₆H₁₀C(CF₃)₂C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂C₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C6H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —OC₆H₁₀(CH₂)₆C₆H₁₀O—), 4-hydroxymethylcyclohex-1-yl (i.e., 4-HOCH₂C6H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C3-C10 cycloaliphatic radical” includes cycloaliphatic radicals containing at least three but no more than 10 carbon atoms. The cycloaliphatic radical 2-tetrahydrofuranyl (C₄H₇O—) represents a C4 cycloaliphatic radical. The cyclohexylmethyl radical (C₆H₁₁CH₂—) represents a C7 cycloaliphatic radical. In some embodiments, the cycloaliphatic groups may include C3-C20 cyclic groups, C5-C15 cyclic groups, C6-C10 cyclic groups, or C8-C10 cyclic groups.

As used herein, the term “aliphatic group” and “aliphatic radical” are used interchangeably and refers to an organic radical having a valence of at least one consisting of a linear or branched array of atoms that is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkenyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C6 aliphatic radical comprising a methyl group, the methyl group being a functional group that is an alkyl group. Similarly, the 4-nitrobut-1-yl group is a C4 aliphatic radical comprising a nitro group, the nitro group being a functional group. An aliphatic radical may be a haloalkyl group which comprises one or more halogen atoms which may be the same or different. Halogen atoms include, for example, fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilylpropyl (i.e., (CH₃O)₃SiCH₂CH₂CH₂—), vinyl, vinylidene, and the like. By way of further example, a C1-C10 aliphatic radical contains at least one but no more than 10 carbon atoms. A methyl group (i.e., CH₃—) is an example of a C1 aliphatic radical. A decyl group (i.e., CH₃(CH₂)₉—) is an example of a C10 aliphatic radical. In one or more embodiments, the aliphatic groups or aliphatic radical may include, but is not limited to, a straight chain or a branched chain hydrocarbon having 1-20 carbon atoms, 2-15 carbon atoms, 3-10 carbon atoms, or 4-8 carbon atoms.

The term “dimensional stability” as used herein is an attribute of the electrochemical membrane/separator that encompasses no or reduced shrinkage and no curling at the edges. The less is the shrinkage and/or curling, the more is the dimensional stability of the electrochemical membrane/separator.

The present technology provides surface modifying composition and the use of such in a variety of applications. The surface modifying composition comprises one or more surface modifying agents. The surface modifying composition modifies and/or forms the surface of a component in an electrochemical cell or device. In some embodiments, the surface modifying composition modifies the surface of an electrochemical substrate of an electrochemical cell such as a secondary battery. In one or more embodiments, the surface modifying composition includes and can be provided as a coating for an electrochemical membrane separator, coating for active particles, and as a binding agent material (for use in an electrode slurry, e.g., an anode slurry). The terms “electrochemical membrane separator” and “separator” are interchangeably used hereinafter

The surface modifying composition comprises one or more surface modifying agents. In one embodiment, the surface modifying composition is capable of forming a resin or a film. The film formed from the composition can be used in different components of energy generation and storage devices such as, for example, batteries. In one embodiment, the present composition is suitable for forming a film that can be employed as a coating on a separator in a battery. In another embodiment, the composition can be used to form a film on an electrode active material that can be used as a binding agent in a battery. In some other embodiments, the composition can also be used to modify the surface when attached to a surface of a substrate and functions as coupling agents, for example, silane coupling agents. Depending on the application or intended use of the film formed from the composition, the composition may further comprise other components as described further herein.

In one embodiment, the surface modifying composition comprises one or more surface modifying agents represented by Formula 1:

(R)ₐ(W)_{b}(R)_{a″} Formula 1

wherein a, a″ or b is zero or an integer greater than zero, with the proviso that (a+a″+b) is always greater than 0,
R is represented by Formula (1a) which is linear or branched:

(CH₂)_{c}(CH₂O)_{d}(CHOH)ₑ(X)_{g} Formula (1a)

X is independently a group represented by Formula (1b)

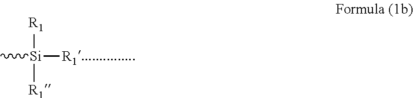

R₁, R₁′, and R₁″ are independently a hydrogen or C₁-C₂₀ alkyl radical, C₁-C₂₀ alkoxy radical, a C₆-C₂₀ aromatic radical, a hydroxyl radical, a hydrogen radical, a C₁-C₂₀ unsubstituted or substituted hydrocarbon, a C₁-C₂₀ fluorinated hydrocarbon, an ether, a fluoroether, an alkylene, a cycloalkylene, an arylene alkylene, a monovalent cyclic or acyclic, a methacrylate, a substituted or un-substituted carboxylate radical or epoxy radical, a C₁-C₁₀ carbonate or carbonate ester, c, d, e, and g are each independently zero or an integer greater than zero with the proviso that c+d+e+g>0,
W is a group represented by Formula (1c)

(Y)ₕ(Z)ᵢ Formula (1c)

wherein h and i are independently zero or an integer greater than zero with the proviso that h+i>0, Y in formula (1c) is a group represented by Formula (1d):

(M₁)_{x″}(D₁)ⱼ(D₂)ₖ((T₁)_{m′}(Q₁)_{n′}(M₂)_{y″} Formula (1d)

wherein j, k, l, m′, n′, x″, and y″ are each independently zero or an integer greater than zero with the proviso that (j+k+m′+n′+x″+y″)>0.
wherein M₁ is a group represented by Formula (1e):

R₂R₃R₄SiI_{1/2} Formula (1e)

D₁ is a group represented by Formula (1f):

R₅R₆SiI_{2/2} Formula (1f)

D₂ is a group represented by Formula (1g):

R₇R₈SiI_{2/2} Formula (1g)

T₁ is a group represented by Formula (1h):

R₉SiI_{3/2} Formula (1h)

Q₁ is a group represented by Formula (1i):

SiI_{4/2} Formula (1i)

M₂ is a group represented by Formula (1j):

R₁₀R₁₁R₁₂SiI_{1/2} Formula (1j)

R₂-R₁₂ is independently R, R₁, R_{1′}, or R_{1″},
I is O or CH₂ group subject to the limitation that the molecule contains an even number of O_{1/2} and even number of (CH₂)_{1/2}, Z in Formula (1c) is independently urethane, urea, anhydride, amide, imide, hydrogen radical, or a monovalent cyclic or acyclic, aliphatic or aromatic, substituted or un-substituted hydrocarbon, or a fluorinated hydrocarbon having 1-20 carbon atoms; wherein the surface modifying agents, when in contact with a surface of an electrochemical substrate, modify the surface of the substrate.

In one or more embodiments, the surface modifying composition comprises two parts, a first part, wherein W of the formula 1 is represented by the formula:

(Y₁)ₕ(Z₁)ᵢ Formula (1k); and

a second part, wherein W of the formula 1 is represented by the formula:

(Y₂)ₕ(Z₂)ᵢ Formula (1l)

wherein Y₁ is represented by

(M₁)_{x″}(D₁)ⱼ(D₂)ₖ(M₂)_{y″} (1k′)
wherein M₁ is R₂R₃R₄SiI_{1/2};
D₁ is R₅R₆SiI_{2/2};
D₂ is R₇R₈SiI_{2/2}; and
M₂ is R₁₀R₁₁R₁₂SiI_{1/2};
where R₂ and R₁₂ are each independently selected from an alkene radical; R₃-R₈ and R₁₀-R₁₁ are each independently selected from a C1-C20 alkyl radical; a C1-C20 substituted or unsubstituted hydrocarbon; and

wherein Y₂ is represented by

(M₁)_{x″}(D₁)ⱼ(D₂)ₖ(M₂)_{y″} (1l′)
where M₁ is R₂R₃R₄SiI_{1/2};
D₁ is R₅R₆SiI_{2/2};
D₂ is R₇R₈SiI_{2/2}; and
M₂ is R₁₀R₁₁R₁₂SiI_{1/2};
wherein R₂, R₃, R₄, R₅, R₆, R₇, R₈, R₁₀, R₁₁, R₁₂ are each independently selected from C1-C20 alkyl radical, substituted alkyl radical, or hydrogen, and wherein at least one of R₂-R₈ and R₁₁-R₁₂ groups is hydrogen; and Z₁ and Z₂ are independently chosen from Z. In some of these embodiments, the R₂ and R₁₂ of the composition are in terminal positions. In some embodiments, the R₂ and R₁₂ of the composition are in terminal positions and are each independently a C1-C20 alkene radical containing a fluorine atom.

In one embodiment, Yᵢ is of the formula (1m) wherein n is an integer in the range from 1 to 1000:

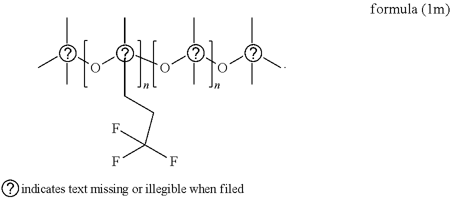

In one embodiment, Y₂ is of the formula (1n), wherein n is an integer in the range from 1 to 1000:

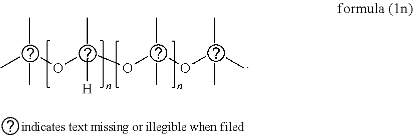

In still another embodiment, the surface modifying agent may contain carbonate (—O—C(O)—O—) groups. The carbonate functional group can be a repeating group to provide a polycarbonate functional group. The surface modifying agent can be in accordance with Formula 1 where the surface modifying agent comprises a carbonate functional group. In one embodiment, the surface modifying agent is a polydimethyl siloxane with terminal aliphatic or aromatic polycarbonate blocks. In some embodiment, R₂ and R₁₂ of formula (1k) are in terminal positions and are C1-C20 carbonate. In one embodiment, the surface modifying agent is represented by:

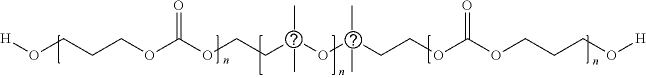

where n is an integer in the range from 1 to 1000.

In some embodiments, the surface modifying agent is a siloxane-based compound comprising a polyalkylene oxide functional group. Such surface modifying agent may have a structure falling under Formula 1(c), where Y has a siloxane structure based on Formula (1d) where one or more of R₂ to R₁₂ of M₁, M₂, D₁ D₂, or T₁ is a polyalkylene oxide group. In some embodiments, the surface modifying agent is a siloxane-based compound comprising a polyalkylene oxide functional group, where W of formula 1 is represented by:

(M₁)_{x″} Formula (1d′)

wherein x″>0, and wherein M₁ is a group represented by Formula (1e):

R₂R₃R₄SiI_{1/2} Formula (1e)

where one or more of the R₂-R₄ groups is a polyalkylene oxide functional group; and wherein I is O with the proviso that the molecule contains an even number of O_{1/2}. In one embodiment, the surface modifying agent is represented by:

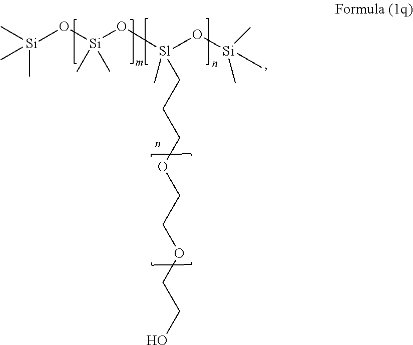

where m and n are independently integers in the range from 1 to 500.

In another embodiment, the surface modifying agent is a silylated polyurethane. In one or more embodiments, the surface modifying agent of Formula 1 is a silylated polyurethane (SPUR) where Z in Formula 1(c) is a urethane and where Y, i, and h have the meaning as describe above for Formula 1. In one embodiment, the surface modifying agent of Formula 1 may be a silylated polyurethane (SPUR) where Z of Formula 1(c) is urethane and Y represents a siloxane polymer chain, and both h and i are independently 1 or greater than 1. In these embodiments, the surface modifying composition is moisture curable composition. The moisture curable compositions may be obtained by various methods including (i) reacting an isocyanate-terminated polyurethane (PUR) prepolymer with a suitable silane, e.g., one possessing both hydrolyzable functionality at the silicon atom, such as, alkoxy, etc., and secondly active hydrogen-containing functionality such as mercaptan, primary or secondary amine, preferably the latter, etc., or by (ii) reacting a hydroxyl-terminated PUR (polyurethane) prepolymer with a suitable isocyanate-terminated silane, e.g., one possessing one to three alkoxy groups. The details of these reactions, and those for preparing the isocyanate-terminated and hydroxyl-terminated PUR prepolymers employed therein can be found in, amongst others: U.S. Pat. Nos. 4,985,491; 5,919,888; 6,207,794; 6,303,731; 6,359,101; and 6,515,164, and published U.S. Patent Publication Nos. 2004/0122253 and US 2005/0020706 (isocyanate-terminated PUR prepolymers); U.S. Pat. Nos. 3,786,081 and 4,481,367 (hydroxyl-terminated PUR prepolymers); U.S. Pat. Nos. 3,627,722; 3,632,557; 3,971,751; 5,623,044; 5,852,137; 6,197,912; and 6,310,170 (moisture-curable SPUR (silane modified/terminated polyurethane) obtained from reaction of isocyanate-terminated PUR prepolymer and reactive silane, e.g., aminoalkoxysilane); and, U.S. Pat. Nos. 4,345,053; 4,625,012; 6,833,423; and published U.S. Patent Publication 2002/0198352 (moisture-curable SPUR obtained from reaction of hydroxyl-terminated PUR prepolymer and isocyanatosilane). The entire contents of the foregoing U.S. patent documents are incorporated by reference herein. Other examples of moisture-curable SPUR materials include those described in U.S. Pat. No. 7,569,653, the disclosure of which is incorporated by reference in its entirety.

In some embodiments, the surface modifying agent is a highly cross-linked polymer having a ladder-like or cage-like structure and comprising a desired functional group. The terms “ladder-like” may also be used herein after as “ladder configuration” and the term “cage-like” is also used hereinafter as “cage configuration”. In one embodiment, the ladder-like or cage-like silicone structures comprise an epoxy functional group to provide an epoxy functional silicone polymer. In one embodiment, the epoxy functional group is a glycidyl ether functional group. The epoxy functional silicone polymer may include other functional groups as desired. In one embodiment, the ladder-like or cage-like silicone polymers containing an epoxy functional group may further include any other functional group selected from R, R₁, R_{1′}, or R_{1″}. In embodiments, the ladder-like or cage-like silicone polymer includes an ether group (e.g., —O—(CH₂)_{b′}CH₃ where b′ is 0-10), a C1-C10 alkyl radical, or a combination thereof.

In one embodiment, Y is a siloxane represented by:

(T₁)ₘ Formula (1d″)

wherein m is 1 or an integer greater than 1, and T₁ is a group represented by Formula

(1h):R₉SiI_{3/2} Formula (1h)

where R₉ is R, R₁, R_{1′}, or R_{1″}, and

where I is O, subject to the limitation that the molecule contains an even number of O_{1/2}.

In one embodiment, R₉ is C₁-C₂₀ alkoxy radical, a C₁-C₂₀ alkyl radical, or a combination thereof. In some embodiments, R⁹ is an ether group —O—(CH₂)_{b′}CH₃ where b′ is 0-10.

In embodiments, the surface modifying agent has the formula (1d″) and has a ladder configuration or a cage configuration.

In some embodiments, the surface modifying agent has a ladder configuration, as represented by the formula (1-o-i to 1-o-ix), where n is an integer in the range from 1 to 500:

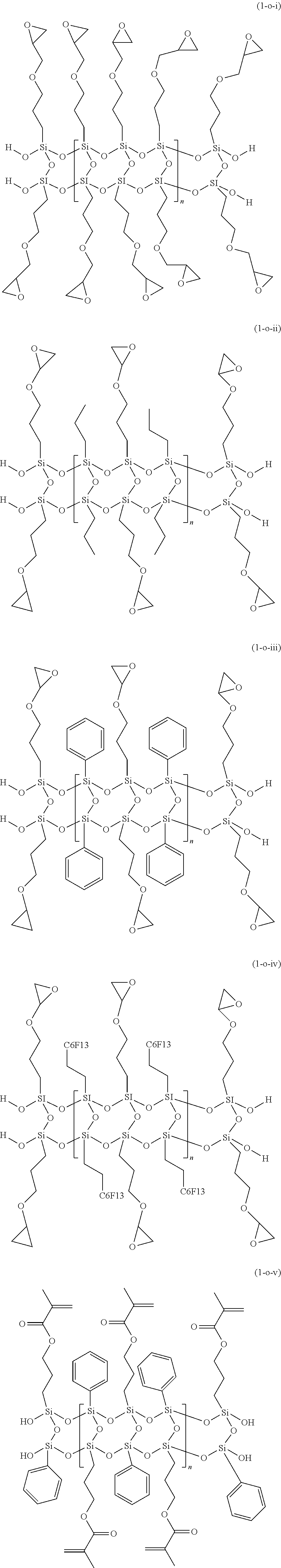

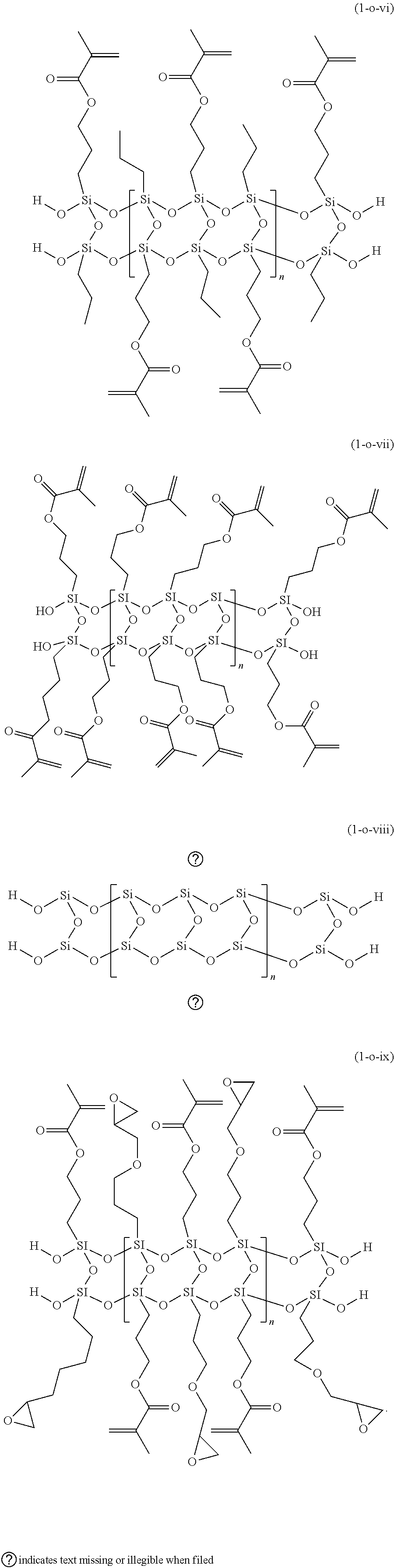

In one embodiment, the surface modifying agent is a silsesquioxane having a cage configuration and represented by formula (1-o-x) where n is an integer in the range from 1 to 500:

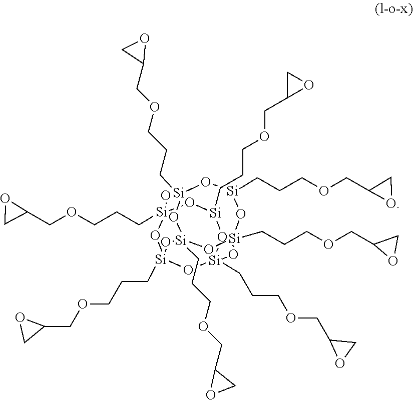

In one embodiment, the surface modifying composition comprises a surface modifying agent, wherein the surface modifying agent is a silane. In such embodiments, in the composition of formula 1, a is 1 when a″ is 0; or a is 0 when a″ is 1 with the proviso that b is 0, the surface modifying agent is represented by formula (1b′):

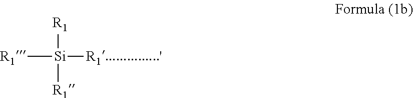

where R₁, R_{1′}, R_{1″}, and R_{1″′} are each independently a hydrogen or C₁-C₂₀ alkyl radical, C₁-C₂₀ alkoxy radical, a C₆-C₂₀ aromatic radical, a hydroxyl radical, a hydrogen radical, a C₁-C₂₀ unsubstituted or substituted hydrocarbon, a C₁-C₂₀ fluorinated hydrocarbon, an ether, a fluoroether, an alkylene, a cycloalkylene, an arylene alkylene, a monovalent cyclic or acyclic, a methacrylate, a substituted or un-substituted carboxylate radical or epoxy radical, a C₁-C₁₀ carbonate or carbonate ester.

Electrochemical Cell

In aspects of the invention, the surface modifying composition can be utilized in an electrochemical cell. The electrochemical cell includes, but is not limited to, an anode, a cathode, a separator, a binding agent, and an electrolyte.

As described above, the surface modifying agent, when in contact with a surface of an electrochemical substrate, modifies the surface of the substrate. In such embodiments, the electrochemical substrate is an electrode, a separator, a binding agent, an electrode active material, or a combination thereof.

In one or more embodiments, the surface modifying agent modifies the surface of the substrate by formation of a film. In some embodiments, the surface modifying agent modifies the surface of the substrate by formation of a coating. In one embodiment, the surface modifying composition is used to form a coating on a separator. In some other embodiments, the surface modifying agent modifies the surface of the substrate by binding the particles of the substrate. In such embodiments, the surface modifying composition is employed as a binding agent for the active material of anode or cathode. In still another embodiment, the surface modifying composition is employed as a surface modifying agent for active particles employed in an electrochemical cell.

The kind of the electrochemical cell is not particularly limited, and may be a battery of a kind known in the art. Specifically, the electrochemical cell of the present invention may be a lithium secondary battery such as a lithium metal secondary battery, a lithium ion secondary battery, a lithium polymer secondary battery or a lithium ion polymer secondary battery. In some embodiments, the electrochemical substrate is disposed in a non-aqueous secondary battery.

A process for preparing a surface modifying composition is also provided herein. The process comprises contacting the one or more surface modifying agents with a solvent to prepare a slurry, wherein the one or more surface modifying agents is represented by Formula 1.

A process for preparing a surface-modified electrochemical substrate is also provided, wherein the process comprises contacting the surface modifying composition to an electrochemical substrate.

The method for producing the electrochemical cell of the present invention is not particularly limited, and any method commonly used in the art may be used. A non-limiting example of a method of manufacturing the electrochemical cell is as follows: a polymeric-based separator is placed between a positive electrode and a negative electrode of the battery, and then the battery is filled in such a manner as to fill an electrolyte solution. In one embodiment, the separator is coated with a film formed from the surface modifying composition comprising the surface modifying agent. In one embodiment, the positive or negative electrode is formed from a composition comprising a binding agent material that comprises the surface modifying agent.

The electrode constituting the electrochemical cell of the present invention can be produced in a form in which the electrode active material is bound to the electrode current collector by a method commonly used in the technical field of the present invention. Among the electrode active materials used in one embodiment of the present invention, the cathode active material is not particularly limited, and a cathode active material commonly used in the technical field of the present invention may be used. Non-limiting examples of the positive electrode active material include lithium manganese oxide, lithium cobalt oxide, lithium nickel oxide, lithium iron oxide or a lithium composite oxide in combination thereof.

The negative electrode active material of the electrode active material used in one embodiment of the present invention is not particularly limited and may be a negative electrode active material commonly used in the technical field of the present invention. Non-limiting examples of the negative electrode active material include lithium adsorption materials such as lithium metal or lithium alloy, carbon, petroleum coke, activated carbon, graphite (graphite) or other carbons, and the like. The electrode current collector used in one embodiment of the present invention is not particularly limited, and an electrode current collector commonly used in the technical field of the present invention may be used.

Non-limiting examples of the positive electrode current collector material of the electrode current collector may be a foil made of aluminum, nickel, or a combination thereof. Non-limiting examples of the negative electrode current collector material of the electrode current collector may be a foil produced by copper, gold, nickel, copper alloy or a combination thereof.

The electrolyte solution used in the present invention is not particularly limited and may be any suitable electrochemical cell electrolyte solution used in the technical field of the present invention. The electrolyte solution may be one in which a salt having a structure such as A⁺B⁻ is dissolved or dissociated in an organic solvent. Non-limiting examples of A⁺ include a cation consisting of an alkali metal cation such as Li⁺, Na⁺, or K⁺, or a combination thereof. Non-limiting examples of B⁻ anions include the, PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻ or C(CF₂SO₂)₃⁻, or may be an anion consisting of a combination thereof. Non-limiting examples of the organic solvent include propylene carbonate (PC), ethylene carbonate (EC), diethyl carbonate (DEC), dimethyl carbonate (DMC), dipropyl carbonate (DPC), dimethyl sulfoxide (DMSO), acetonitrile, dimethoxyethane, diethoxyethane, tetrahydrofuran (THF), N-methyl-2-pyrrolidone (NMP), ethyl methyl carbonate (EMC), gamma-butyrolactone (GBL), etc. are mentioned. These may be used alone or in combination of two or more thereof.

Separator Coating

The surface modifying composition comprising the surface modifying agent(s) can be employed as part of a separator material. In one embodiment, the surface modifying composition comprising the surface modifying agent(s) is used to form a coating or film on a polymeric film or substrate separator. In one embodiment, the surface modifying composition comprising the surface modifying agent(s) is coated onto a substrate and cured to form a film.

The separator can be formed from any material suitable as a separator in an electrochemical cell. In on embodiment, the separator film/substrate is formed from a polyolefin such as polyethylene, polypropylene, polyisobutylene, and ethylene-alpha-olefin copolymers; an acrylic polymer and copolymer such as polyacrylate, polymethylmethacrylate, polyethylacrylate; a polyvinyl ether such as polyvinyl methyl ether; polyacrylonitrile; polyvinyl ketones; a polyvinyl aromatic such as polystyrene; polyvinyl esters, such as polyvinyl acetate; a copolymer of vinyl monomers with each other and olefins, such as ethylene-methyl methacrylate copolymers, acrylonitrile-styrene copolymers, ABS resins, and ethylene-vinyl acetate copolymers; a natural or synthetic rubber, including butadiene-styrene copolymers, polyisoprene, synthetic polyisoprene, polybutadiene, butadiene-acrylonitrile copolymers, polychloroprene rubbers, polyisobutylene rubber, ethylene-propylene rubber, ethylene-propylene-diene rubbers, isobutylene-isoprene copolymers, and polyurethane rubbers; a polyester, such as polyethylene terephthalate; polycarbonates; polyimides; and a polyether. Particularly suitable materials for the support substrate are polyolefins such a polypropylene or polyethylene.

In one embodiment, the substrate of the separator is coated with a film formed from a surface modifying composition comprising the surface modifying agent as described herein. In one non-limiting embodiment, the surface modifying composition comprises a surface modifying agent of Formula 1. In one embodiment, the surface modifying agent comprises a vinyl fluorosiloxane resin and a silyl hydride such as, for example, the materials of formula (1x) and (1x-i):

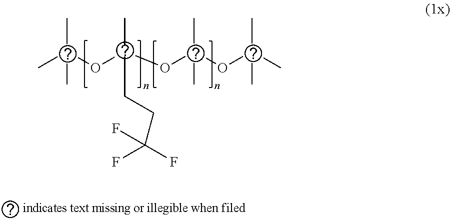

where n can be an integer from 1-1000;

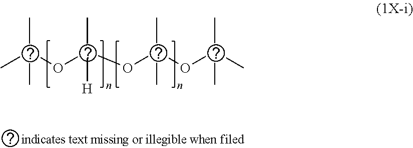

where n can be an integer from 1-1000.

In another embodiment, the surface modifying composition for forming the film comprises a silsesquioxane ladder-type polymer or a cage-type polymer. Examples of such materials include, but are not limited to, those of formula (1-o-i to 1-o-x) as previously described herein.

In one embodiment, the surface modifying composition for forming the film on the separator comprises a surface modifying agent selected from a siloxane based compound modified with a polyalkylene oxide functional group. Examples of such materials include, but are not limited to those formula (1-o-i to 1-o-x) as previously described herein.

It will be appreciated that the composition for coating the separator can include a combination of two or more different silicone-containing polymers.

The surface modifying composition for coating the separator optionally includes a filler. The surface modifying composition for coating the separator may comprise one or more fillers, wherein the fillers include, but are not limited to, alumina, silicon, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, graphene, metal coated graphite, metal coated graphene, aluminum powder, copper powder, bronze powder, brass powder, fibers or whiskers of carbon, graphite, silicon carbide, silicon nitride, alumina, aluminum nitride, silver, zinc oxide, carbon nanotubes, boron nitride nanosheets, zinc oxide nanotubes, black phosphorous, silver coated aluminum, silver coated glass, silver plated aluminum, nickel plated silver, nickel plated aluminum, carbon black of different structures, Monel mesh and wires, and combinations of two or more thereof.

In one embodiment, the filler can be selected from polymeric particles chosen from methylsilsesquioxane resin microspheres. Non-limiting examples of such materials include those sold under the tradename TOSPEARL® available from Momentive Performance Materials Inc. Some examples of suitable fillers include, but are not limited to, TOSPEARL® 150KA, TOSPEARL® 1110A, TOSPEARL® 120A, TOSPEARL@ 145A, TOSPEARL® 2000B, TOSPEARL@ 3000A.

In one embodiment, the fillers can be added up to about 70 wt. % with respect to the formulation. The filler can be included in an amount of from about 0.1 wt. % to about 5 wt. %, from about 0.1 wt. % to about 10 wt. %, or from about 0.1 wt. % to about 20 wt. % based on the weight of the dried coating.

The surface modifying composition for coating the separator can optionally include a solvent. The solvent can be selected as desired for a particular purpose or intended application. The solvent may be a polar and/or non-polar solvent such as methanol, ethanol, n-butanol, t-butanol, n-octanol, n-decanol, 1-methoxy-2-propanol, isopropyl alcohol, ethylene glycol, hexane, decane, isooctane, benzene, toluene, the xylenes, tetrahydrofuran, dioxane, diethyl ether, dibutyl ether, bis(2-methoxyethyl)ether, 1,2-dimethoxy ethane, acetonitrile, benzonitrile, aniline, phenylenediamine, phenylenediamine, chloroform, acetone, methylethyl ketone, dimethylformamide (DMF), dimethyl sulfoxide (DMSO), N-methylpyrrolidinone (NMP), and propylene carbonate.

The surface modifying composition for coating the separator may be UV cured after applying the formulation onto a suitable polymeric substrate (e.g., polycarbonate substrates).

The surface modifying composition may be cured using any suitable irradiation source. In embodiments, the irradiation source is an ultraviolet source providing light whose wavelength is in the range of preferably from 180 to 600 nm, more preferably 190-500 nm, are used. The light-irradiation intensity (radiation dose*exposure time per unit of volume) is selected as a function of the selected process, of the selected composition of the temperature of the composition in such a way as to give a sufficient processing time. Commercially available irradiation sources may be used in the irradiation step of the present invention. Examples of suitable sources include those available from Dymax. The source may have an output of from about 200 to about 1,000 mJ/cm² at about 120 to about 200 mW/cm². Other available light sources include those available from UV Fusion. Average exposure times (time which is required to pass the irradiation unit(s)) is for example at least 1 second, preferably 2 to 50 seconds. For instance, the disclosed composition may be cured by actinic radiation in the ultraviolet (UV) or visible spectrum, both of which can encompass actinic radiation or by electron beam (EB) radiation.

The surface modifying composition for coating the separator may include a catalyst. Suitable catalysts include, but are not limited to, the dialkyltin dicarboxylates such as dibutyltin dilaurate and dibutyltin acetate, tertiary amines, the stannous salts of carboxylic acids, such as stannous octoate and stannous acetate, and the like. Other useful catalysts include, but are not limited to, zirconium-containing and bismuth-containing complexes such as KAT XC6212, K-KAT XC-A209 and K-KAT 348, supplied by King Industries, Inc., aluminum chelates such as the TYZER® types, available from DuPont company, and the KR types, available from Kenrich Petrochemical, Inc., and other organometallic catalysts, e.g., those containing a metal such as Zn, Co, Ni, Fe, and the like.

In some embodiments, the composition comprises about 0.0001 wt. % to about 0.1 wt. % of catalyst. In some other embodiments, the composition comprises about 0.0005 wt. % to about 0.001 wt. % of catalyst. In some other embodiments, the composition comprises about 0.001 wt. % to about 0.1 wt. % of catalyst. In some other embodiments, the composition comprises about 0.005 wt. % to about 0.1 wt. % of catalyst. In some other embodiments, the composition comprises about 0.005 wt. % to about 1 wt. % of the catalyst.

In one embodiment, an electrochemical substrate coated with the present surface modifying compositions has a shrinkage of 10% or less, 7.5% or less, 5% or less, 2.5% or less, 1% or less, even 0.5% or less when heated at 200° C. for 3 minutes.

In one embodiment, an electrochemical substrate coated with the present surface modifying compositions exhibits an electrolyte uptake of 100% or greater at 25° C. as compared to an uncoated substrate.

Binding Agent

In one embodiment, the surface modifying composition can be employed as a binding agent material in an anode active material composition. The anode active material composition can be provided as a slurry and may be referred to herein as the anode slurry. The anode slurry can comprise an active material, a conductive agent, a binding agent material, and a solvent. The surface modifying composition is mixed with the slurry.

Examples of suitable active materials include, but are not limited to, graphite, crystalline carbon, silicon, or silicon carbide. Examples of suitable graphite materials include artificial graphite, natural graphite, fiber graphite, etc. The amount of active anode material in the anode slurry can be from about 50 wt. % to about 90 wt. %, from about 60 wt. % to about 85 wt. %, or from about 70 wt. % to about 80 wt. %.

In one embodiment, the conductive agent is selected from carbon black, acetylene black, or graphite. The active agent can be present in an amount of from about 1 wt. % to about 20 wt. %, from about 5 wt. % to about 15 wt. %, or from about 7 wt. % to about 10 wt. %.

The binding agent can comprise a surface modifying composition comprising a surface modifying agent in accordance with the present invention. The surface modifying composition can be used alone or with other materials to form the binding agent.

In one embodiment, the binding agent comprises a polyalkylene oxide modified silicone polymer. In one embodiment, the binding agent comprises a composition comprising a polyakylene oxide modified silicone polymer and acrylate emulsion polymer. The acrylate emulsion polymer can be a styrene acrylate emulsion polymer. A “styrene acrylate emulsion polymer” is an emulsion polymer comprising at least 50% by weight of polymerized units that are derived from either ethylenically unsaturated (meth)acrylates or styrene, and wherein the polymer comprises at least 5% of each of these types of polymerized unit. Examples of suitable styrene-acrylic emulsion polymers include, but are not limited to, those sold under the tradename Rhoplex™. In a binding agent composition that includes a mixture of the polyalkylene oxide modified silicone polymer and the acrylic emulsion, the polyalkylene oxide is present in an amount of from about 1 wt. % to about 70 wt. %, from about 0.5 wt. % to about 50 wt. %, or from about 0.1 wt. % to about 70 wt. % and the emulsion polymer is present in an amount of from about from about 0.1 wt. % to about 50 wt. %, from about 0.5 wt. % to about 70 wt. %, or from about 0.1 wt. % to about 70 wt. %.

In one embodiment, the surface modifying composition employed as a binding agent is selected from a polyalkylene modified silicone polymer of the formula 1d, where one or more of R₂, R₃, R₄, R₅, R₆, R₇, R₈, R₁₈, R₁₉, and R₂₀ of M₁ or D₁ or T or Q. is selected from a polyalkylene oxide group. In one embodiment, one of R₅ or R₆ is a polyalkylene oxide functional group.

In one embodiment the binding agent has the structure:

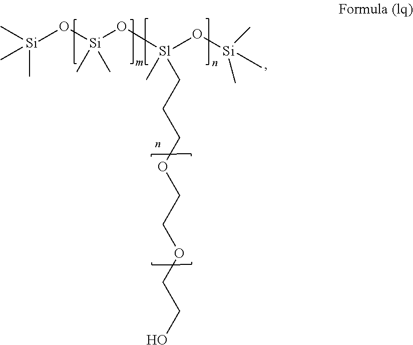

where n and m can be between 1 to 500

In still another embodiment, the binding agent is selected from a silylated polyurethane material.

The binding agent material can be present in an amount of up to 10 wt. %. In one embodiment, the binding agent is present in an amount of from about 0.1 wt. % to about 10 wt. %, from about 1 wt. % to about 8 wt. %, from about 2 wt. % to about 6 wt. %, or from about 4 wt. % to about 5 wt. %.

The anode slurry also includes a solvent. The solvent can be selected as desired for a particular purpose or intended application. In one embodiment, the solvent is water. In one embodiment, the solvent is an organic solvent such as, but not limited to, N-methyl-2pyrrolidone (NMP), acetone, dimethylacetamide (DMA), and dimethylformamide (DMF).

The anode slurry may also include other materials suitable for such compositions including, but not limited to thickeners, dispersants, etc.

The binding agent should be sufficiently adhesive to adhere to the electrode (i.e., anode or cathode). If necessary, the binding agent composition can further include one or more adhesives to facilitate adhesion. Suitable adhesive materials include, but are not limited to, polymers and copolymers of poly(vinyl acetate)-based adhesives (PVAc), polyester- or polyol-based polyurethanes, styrene-butadiene copolymers and terpolymers, ethylene-propylene and ethylene-propylene-diene synthetic rubbers, polyolefins, poly(vinylidene fluoride), and polyamides. Mixtures of such binding agents are also useful. Exemplary binding agents are poly(vinyl acetate)-based materials such as poly(vinyl acetate), poly(vinyl acetate-co-vinyl alcohol) and poly(ethylene-co-vinyl acetate).

Electrode Active Material

In one embodiment, the surface modifying composition comprising the surface modifying agent can be employed to coat an electrode active material (e.g., an anode active material or a cathode active material). In embodiments, the surface modifying composition for coating the active material comprises a silane of the formula (1b′) as described herein. The anode active material being coated is not particularly limited and can be selected as desired for an intended purpose or application. Examples of cathode electrode materials can include, but are not limited to, MnO₂, NiO, NiOOH, Cu(OH)₂, Cobalt Oxide, PbO₂, AgO, Ag₂O, Ag₂Cu₂O₃, CuAgO₂, CuMnO₂, and suitable combinations of two or more thereof. In one embodiment, the anode active material may include at least one element or compound selected from the group consisting of Si, Sn, Li, Zn, Mg, Cd, Ce, Ni, Fe and oxides thereof. In another embodiment, the anode active material includes, but are not limited to, graphite, spheroidal natural graphite, mesocarbon microbeads (MCMB), and carbon fibers (e.g., mesophase carbon fibers).

In one embodiment, modifying the electrode active material, which may be in particulate form, with the present surface modifying compositions provides particulate aggregates. Such particulate aggregates have been found to display enhanced capacity retention of the electrode compared to the unmodified particles. In one embodiment, particulate aggregates formed from modifying electrode active material with the surface modifying agent exhibits a retention of specific capacity of 38% or greater, 40% or greater, 45% or greater, 50% or greater, even 80% or greater and lesser than 99% after 500 cycles at a current density of 100 mA/g.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### EXAMPLES

### Example 1: Preparation of Fluorosilicone Surface Modifying Composition

In the typical procedure, vinyl fluorosilicone (One part) and hydride (Second part) were mixed in a specified ratio (3:1, 1:1, 1:3) and a specified amount of Pt/PDMS catalyst (20 ppm) were added and mixed well. The mixture is then spread with a doctors' blade on the surface of polypropylene separator. The coated separator is then exposed under UV light for 180 seconds. The exposure to UV activates the catalyst to cure the vinyl with hydride and provides a non-tacky surface on the surface of separator. The coated separator can be then used for analysis.

### Example 2: Preparation of Polycarbonate-b-Polydimethylsiloxane-b-Polycarbonate (PC-b-PDMS-b-PC) Surface Modifying Composition

In a two necked round bottom flask equipped with a dropping funnel and condenser, hydroxyl terminated PDMS was taken in nitrogen atmosphere. Toluene was added and heated at 110° C. and Stannous octoate (0.01 wt. % of reactant) was added. Then, the 1,3-dioxan-2-one added dropwise from dropping funnel and the reaction was stirred for 110° C. for 24 hours. The reaction mixture was cooled and ice cold methanol was added dropwise to get the solid polymer (Yield 90%). The solid polymer was then dissolved in a toluene and was dropped across the surface of polypropylene separator. The coated separator was then dried in an air oven maintained at 70° C. for evaporation of solvent. The coated separator was then used for analysis.

### Example 3: Preparation of Silylated Polyurethane (SPUR) Based Surface Modifying Composition

Step 1: The SPUR formulation comprises polyol, IPDI, isocyanate silane and moisture scavenger. The formulation is received as such and in addition, addition promotor (A235), moisture scavenger (A171) and hydrophobicity developer (A1237) were added. All the ingredients are mixed well and finally DBTDL (dibutyl tin di laurate) was added and mixed well. SPUR—80 wt. %, 137 A—(alkoxy oligomer)—10 wt. % (hydrophobicity); A235—2 wt. % (addition promoter), A171—1 wt. % (moisture scavener), Catalyst—0.1 wt. %.

Step 2: The SPUR mixture is then added to active electrode materials and ground manually in a mortar pestle. To this active material/SPUR mixture, NMP is added in calculated amount in order to obtain a slurry which is coated over the current collector. Active material—90 wt. %, Conducting black—6 wt. %, Binding agent (SPUR formulation)—4 wt. %.

### Example 4: Preparation of POSS (Ladder/Cage) Based Surface Modifying Composition

In a typical procedure, Polysilsesquioxane molecules were synthesized by the reaction of monomeric silane in presence of solvent (THF/water) and base such as potassium carbonate at 40° C. for 16 h. The monomeric silanes comprise molecules such as A174, A187, phenyl trimethoxyl silane, propyl trimethoxy silane. Then the polymeric mixture is extracted in organic solvent and washed with water to remove residual base. The volatiles in the polymeric mixture are removed by rotary evaporator and treated under high vacuum for further purification. The obtained product is viscous liquid with solid content higher than 90%. The formulation with the above resin is prepared using the resin, solvent and UV initiator, and filler and cured under UV light. UV initiator used is tris(pentafluorophenyl) borate. The fillers can comprise TiO₂, ZnO, SiO₂, zirconia etc.

Evaluation of Surface Modified Electrochemical Separators

To evaluate separators for electrochemical devices, polyolefin and ceramic coated polyolefin have been used as benchmarks to study the characteristic changes in features upon coating with the present silicone-containing polymers. In a typical experiment, the separator coating formulations contain resins in 0-50 wt. % and filler 0-20 wt. % with respect to the total formulation and a solvent. The composition also contains 0.01-1 wt. % catalyst. The coating composition are blends of two or more resins having individual resins between 0-40 wt. %.

The composition to be coated is prepared under ambient conditions and coated over the surface of the separator membrane by flow coat or spreading with the help of a doctor blade. Subsequently, the coated separator is air dried for few minutes and cured under ultra-violet ray or thermal oven for a specified duration. The coated separator is then cut in different dimensions for testing of various electrochemical and physicochemical properties as per ASTM standards. The tensile testing of the samples were performed employing ASTM D882 and ASTMD412, puncture strength of separators were determined using ASTM D3763. The electrochemical testing of the coated separators includes preparation of a 2032 type coin cell, on which cyclic voltammetry, cyclic stability, and impedance analysis of the coin cell are performed. In addition, properties such as mechanical, thermal, shrinkage, wettability, solvent uptake capacity, etc. are measured for coated separators.

### Example 5: Preparation of 5% Ladder Type Polysilsesquioxanes Modified Polypropylene

A 5 wt. % propyl and epoxy pendent ladder like polysilsesquioxane (RHEP) was dispersed in 1-methoxypropanol. 1 wt. % of tris(pentafluorophenyl)borane (w.r.t. weight of RHEP) was added to the dispersion and mixed well. A PP sheet of 8 cm×10 cm dimension was coated with this dispersion using flow coating. In the typical procedure the resin and catalyst were dissolved in a suitable solvent flowed over the separator membrane. The resulting coated PP sheet was dried in a hot air oven at 60° C. for 3 min followed by UV curing under 380 nm for 180 seconds (90 seconds for each side). Various formulations of coating and binding agent prepared for testing are mentioned in Table 1 below. In these formulations, tospearl can vary between 0-20 wt %. The range of RHE and RHEP in the formulation can vary between 0-100 wt %. The range of glycidyl POSS in the formulation can vary between 0-100 wt %. The range of PC and PDMS in copolymer may vary between PC:PDMS 5:95 to PC:PDMS 95:5. This copolymer can further be varied between 0-100 wt % in the formulation with other ingredients. The range of fluorovinyl siloxane in the formulation may vary between 0-90 wt %.

Materials: The materials and designations are employed in the examples include Separator film samples of Polypropylene (PP) and Alumina (Al₂O₃) coated polypropylene were purchased from SeparatEx, China.Fluorovinyl siloxane (FS), Epoxy containing ladder-like polysilsesquioxane (RHE); Epoxy and propyl containing ladder-like polysilsesquioxane (RHEP); Glycidyl group containing polyorganosilsesquioxane (GP, cage-like structure); polycarbonate-polydimethyl siloxane block copolymer (PC-PDMS) were developed in laboratory; TOSPEARL® particles (T120; T145: T3000; T4000) were internally procured from Momentive. Synthetic Graphite (<20 μm), PVDF were purchased from Sigma Aldrich, India. Super P conductive carbon was purchased from Alfa Aesar, India.

TABLE 1
Various surface modifying compositions

| Composition | Acronym |
|---|---|
| PP | Polypropylene |
| Al₂O₃/PP | Alumina coated Polypropylene |
| RHE-Al₂O₃/PP | Epoxy functionalized siloxane ladder resin (100 wt %) coated on PP/Al2O3 |
| RHE-PP | Epoxy functionalized siloxane ladder resin (100 wt %) coated on PP |
| RHEP-PP | Epoxy and propyl functionalized siloxane ladder resin (100 wt %) coated on PP |
| RHE/GP-PP | Epoxy functionalized ladder siloxane (50 wt %) blended with glycidyl POSS (50 wt %) |
| | coated on PP |
| RHEP/GP-PP | Epoxy, propryl functionalized ladder siloxane (50 wt %) blended with glycidyl POSS (50 |
| | wt %) coated on PP |
| FS/GP-PP | Fluoro vinyl siloxane (67 wt %) blended with glycidyl POSS (33 wt %) coated on PP |
| FS/RHEP-PP | Fluoro vinyl siloxane (67 wt %) blended with epoxy, propyl functionalized ladder siloxane |
| | resin (33 wt %) coated on PP |
| T145/RHE-PP | Tospearl ® 145 (5 wt %) containing epoxy functionalized resin (95 wt %) coated on PP |
| T145/RHEP-PP | Tospearl ® 145 (5 wt %) containing epoxy, propyl functionalized resin (95 wt %) coated on |
| | PP |
| T145/RHE/GP-PP | Tospearl ® 145 (5 wt %) in epoxy functionalized resin (47.5 wt %)/glycidyl POSS (47.5 |
| | wt %) blend coated on PP |
| T145/RHEP/GP-PP | Tospearl ® 145 (5 wt %) in epoxy, propyl functionalized resin (47.5 wt %)/glycidyl POSS |
| | (47.5 wt %) blend coated on PP |
| T145/FS-PP | Tospearl ® 145 (10 wt %) fluorovinyl siloxane (90 wt %) coated on PP |
| T145/FS/GP/RHEP/PP | Tospearl ® 145 (5 wt %) in fluorovinyl siloxane (47.5 wt %) blended with epoxy, propyl |
| | siloxane resin (23.8 wt %) and glycidyl POSS (23.8 wt %) coated on PP |
| T120/RHEP/GP-PP | Tospearl ® 120 (5 wt %) in blend of epoxy, propyl siloxane resin (47.5 wt %) and glycidyl |
| | POSS resin (47.5 wt %) coated on PP |
| T120/FS/RHEP-PP | Tospearl ® 120 (5 wt %) in blend of fluorovinyl siloxane (63.3 wt %) and epoxy, propyl |
| | siloxane resin (31.7 wt %) coated on PP |
| T120/FS/GP-PP | Tospearl ® 120 (5 wt %) in blend of fluorovinyl siloxane (63.3 wt %) and glycidyl POSS |
| | resin (31.7 wt %) coated on PP |
| T120/FS/GP/REHP- | Tospearl ® 120 (5 wt %) in blend of fluorovinyl siloxane (47.5 wt %), glycidyl POSS resin |
| PP | (23.7 wt %) and epoxy propyl functionalized ladder siloxane resin (23.7 wt %) coated on |
| | PP |
| T2000/RHE-PP | Tospearl ® 2000 (5 wt %) in epoxy functionalized ladder siloxane (90 wt %) coated on PP |
| T3000/RHE-PP | Tospearl ® 3000 (5 wt %) in epoxy functionalized siloxane (90 wt %) coated on PP |
| PVDF/RHEP/GP-PP | Polyvinyl difluoride blended with epoxy, propyl functionalized resin and glycidyl POSS |
| | coated on PP |
| PC/PDMS-PP | Polycarbonate (74.6 wt %) and PDMS copolymer (25.4 wt %) coated on PP |

The properties of the various coating compositions binding agent are shown in Table 2.

TABLE 2
Mechanical and chemical properties of various compositions

| | | Shrinkage | Electrolyte |
|---|---|---|---|
| Sample | Base separator with | (@200° C. | Uptake |
| No | formulation | for 3 min) | (%) |
| 1 | PP | 28% | 100 |
| 2 | Al₂O₃/PP | 100% | 110 |
| 3 | RHE-Al₂O₃/PP | 0% | 147 |
| 4 | RHE-PP | 0% | 140 |
| 5 | RHEP-PP | 0% | 366 |
| 6 | RHE/GP-PP | 0% | 150 |
| 7 | RHEP/GP-PP | 0% | 165 |
| 8 | FS/GP-PP | 5% | 145 |
| 9 | FS/RHEP-PP | 5% | 155 |
| 10 | T145/RHEP-PP | 0% | 120 |
| 11 | T145/RHE/GP-PP | 0% | 180 |
| 12 | T145/RHEP/GP-PP | 0% | 225 |
| 13 | T145/FS-PP | 0% | 126 |
| 14 | T145/FS/GP/RHEP | 5% | 160 |
| 15 | T120/RHEP/GP-PP | 0% | 210 |
| 16 | T120/FS/RHEP-PP | 5% | 155 |
| 17 | T120/FS/GP-PP | 10% | 140 |
| 18 | T120/FS/GP/REHP-PP | 5% | 160 |
| 19 | T2000/RHE-PP | 0% | 145 |
| 20 | T3000/RHE-PP | 0% | 147 |
| 21 | PVDF/RHEP/GP-PP | 0% | 210 |
| 22 | PC/PDMS-PP | 0% | 157 |

POSS ladder and cage molecules and formulations, and vinyl fluorosiloxanes were tested as separator coatings in a coin cell system to determine electrochemical performance. In table 2, an uncoated polypropylene (PP) battery separator is identified as sample 1 and an alumina coated polypropylene is identified as sample 2. Sample 1 and Sample 2 are comparative samples, while Sample Nos. 3 to 22 are polypropylene separator substrates coated with the compositions of the invention

It can be noted from table 2 that PP showed a shrinkage of 28% in its dimensions when treated at 200° C. for 3 min, whereas the alumina coated polypropylene showed 100% shrinkage in its dimensions. On coating with the polypropylene separator substrate with compositions of the invention (Sample Nos. 3-22), a significant improvement in shrinkage property was noted and a maximum of 10% shrinkage was observed. The curling behavior at the edges of the separator was also noted. It was observed that the above polypropylene separator substrates when coated with the compositions of the invention, the separator did not undergo curling upon heat treatment during the operation. This suggests high interfacial interaction between the PP surface and the coating compositions of the invention. This further demonstrates that the electrochemical membrane coated/modified with the surface modifying agent of the present invention consistently improves the dimensional stability of the electrochemical membrane separator as compared to the conventional uncoated PP separator membrane. This illustrates that dimensional stability can be retained in the separators when coated with compositions of the invention as compared to alumina coated separator substrate (Sample No. 2) or uncoated polypropylene substrate.

In addition, compared to the LiPF₆/EC/EMC (1M) electrolyte uptake capacity of the PP and Al₂O₃ coated PP separators, separators coated with compositions of the invention (Sample Nos. 3 to 22) demonstrated improved electrolyte uptake. With uncoated PP as a reference, it can be clearly noted from Table 2 that the coated electrochemical membrane separator of the present invention has significantly improved electrolyte uptake (>100%). With greater uptake of lithium ions greater transport of charge is enabled which in turn assists in retention of specific capacity.

Evaluation of Surface Modified Electrode Particulates

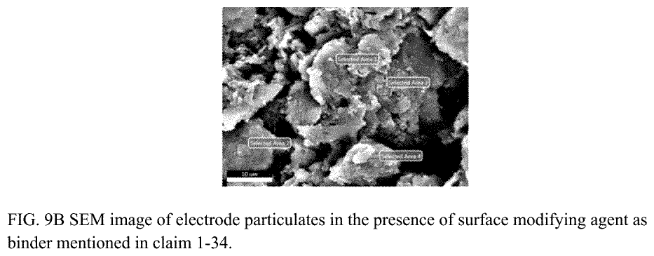

Evaluation of the silicone-containing polymer materials as binding agents included physical mixing of the binding agent material with electrode active material and conductive agent. In a typical experiment, 1-10 wt. % of binding agent is mixed with the electrode active material (50-80 wt. %) and conductive agent (5-10 wt. %) and mixed well to obtain a homogenous solid phase. Thereafter a calculated amount of solvent is added to produce a slurry, which is then coated on a current collector. The electrodes are cut in the shape of coins after drying at the stipulated temperature. The Li-ion coin cells are assembled and tested for cyclic stability and rate capability at various current densities. In addition, the morphology, in-air thermal stability, viscosity, etc. are determined for each surface modifying agent or binding agent material. FIG. 9A: shows the electrode particles without treatment with surface modifying agent, where no aggregate is formed. FIG. 9B shows particulate aggregates that comprises surface modifying agent of the present invention.

An aqueous borne siloxane, and SPUR were tested as binding agents in a coin cell system to determine the electrochemical performance.

Electrochemical Evaluation of Surface Modified Separators and Electrode Particulates

Methods:

Fabrication of Half Cells: Half cells were fabricated using the active material graphite, carbon black, and PVDF (70:20:10), and the slurry was prepared by addition of N-methyl pyrrolidone. The slurry was coated on the copper foil and dried under vacuum for 6 h at 60° C. The electrolyte additives were added in 1 wt. % with respect to the referenced electrolyte LiPF₆/EC/EMC. Lithium was used as counter electrode.

Construction of Coin cells: The cells were constructed by varying the separator placed between the two electrodes, and the performance of the cell was evaluated. In case of the electrochemical performance of new binding agents, the active slurry was prepared by replacing PVDF with alternate binding agents maintaining the amounts of ingredients same.

### Measurement of Cyclic Stability & Rate Capability:

Method of measurement: The cyclic voltammograms were recorded for ten cycles on a Biologic tester at a scan rate of 0.2 mV/s. The cyclic stability and rate capability were tested on a Neware battery tester BTS4000 at different current rates, where the current density was calculated with respect to weight of the mass loaded on copper current collector. The cyclic stability was performed for 50 cycles and rate capability were performed at five different current densities for over 50 cycles.

Surface Modified Electrochemical Separators:

### Example 6: PC-PDMS Copolymer as a Separator Coating

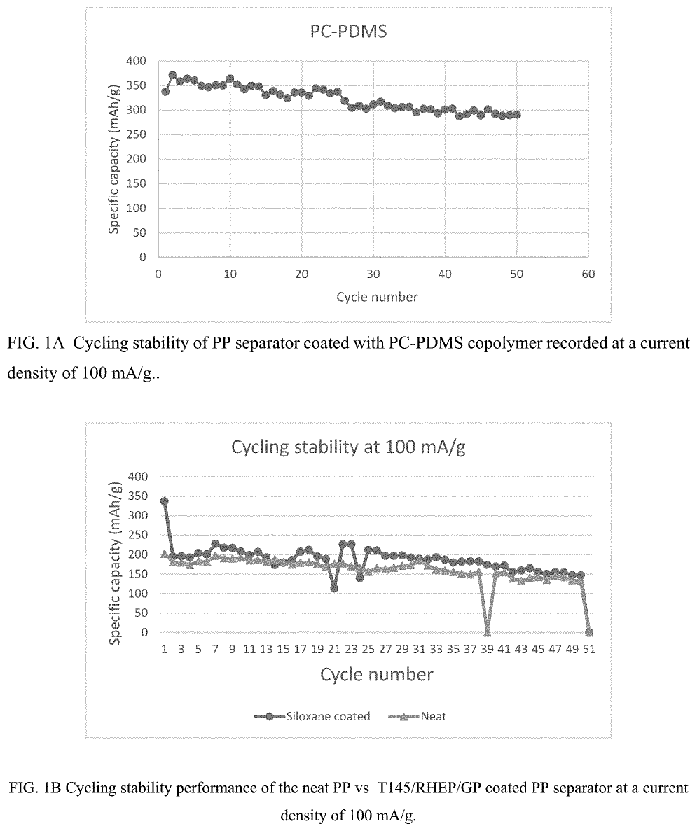

PC-PDMS copolymer was used as a separator coating on a PP battery separator. The anode formulation consisted of graphite and carbon black with PVDF used as a binding agent and lithium metal foil used as counter electrode. The coin cell was analyzed at 100 mA/g current density for 50 cycles and the corresponding electrochemical data is presented in FIG. 1A. The cyclic stability analysis shows that the specific capacity retained at the end of 50 cycles was more than 80% with respect to the specific capacity of the initial cycle. This further suggests that the PC-PDMS copolymer permits easy transfusion of the lithium ions across the separator for an extended number of cycles thereby supporting the retention in specific capacity during extended cycling. In addition, to physicochemical properties, PC-PDMS also supports the electrochemical functioning of the cells.

### Example 7: Cyclic Stability of Siloxane Resin (Tospearl®) Coated Separator Compared to Uncoated Separator

The cyclic stability was measured for an uncoated PP separator (without any coating on it) and T145/RHEP/GP-coated PP separator at a current density of 100 mA/g and the cell analysis was performed for 50 cycles at temperature of 25° C. The cyclic stability data of the uncoated PP separator and a T145/RHEP/GP-coated PP separator at a current density of 100 mA/g. is shown in FIG. 1B. It is noted from the figure that in case of both the cells including an uncoated PP separator and the cells including the T145/RHEP/GP-coated PP separator, the specific capacity at the end of 50 cycles remained similar. It is also noted from this experiment that the T145/RHEP/GP-coated PP showed similar electrochemical stability during extended cycling as compared to the uncoated separator. In addition, the T145/RHEP/GP-coated PP separator also showed improved physicochemical properties such as no curling, no shrinkage and increased electrolyte uptake compared to an uncoated PP separator, as shown in table 2 (composition no. 13). All these improved properties may be due to the presence of the composition of the invention which generally offers thermal resistance and porous characteristics which are essential for extended safety during cycling of electrochemical cells.

Surface Modified Electrode Particulates:

### Example 8: Aqueous Emulsion of Siloxane and Styrene Acrylate (SST2) as Binding Agent

Binding Agent: For testing the binding agents in the coin cells, the 2032 coin half cells were constructed. In the process, copper foil was used as current collector for cathode and bare lithium foil was used as anode. The copper foil was coated with a slurry comprising graphite, conducting carbon black and SST2 as binding agent binding agent. Uncoated polypropylene has been used as separator in the coin cells, placed between a copper coated electrode and a lithium counter electrode.

Mechanical integrity of electrode: The cyclic voltammogram or CV was conducted at a ramp rate of 0.2 mV/s using binding agent SST2, which is an aqueous emulsion of siloxane and styrene acrylate. The data is provided in FIG. 2. The cyclic voltammogram indicated the electrochemical activity of the electrode in the potential window between 0.1-3.0 V. The CV curves showed the consistent workability of the electrode with the presence of typical electrochemical redox peaks corresponding to graphite during charging and discharging. The graphite electrode with SST2 binding agent showed the first discharge curve with a trough starting at around 1.2 V, which continues until the lower voltage indicating the intercalation of lithium ions inside the graphite interstices. Conversely during oxidation, a hump is noted at around 0.7 V, which indicates the exit of lithium ion from graphitic structure. This behavior was noted to repeat over cycles. This in turn suggests that presence of SST2 could provide the structural stability and mechanical integrity to the anode active material under the electrochemical environment during charge-discharge cycles.

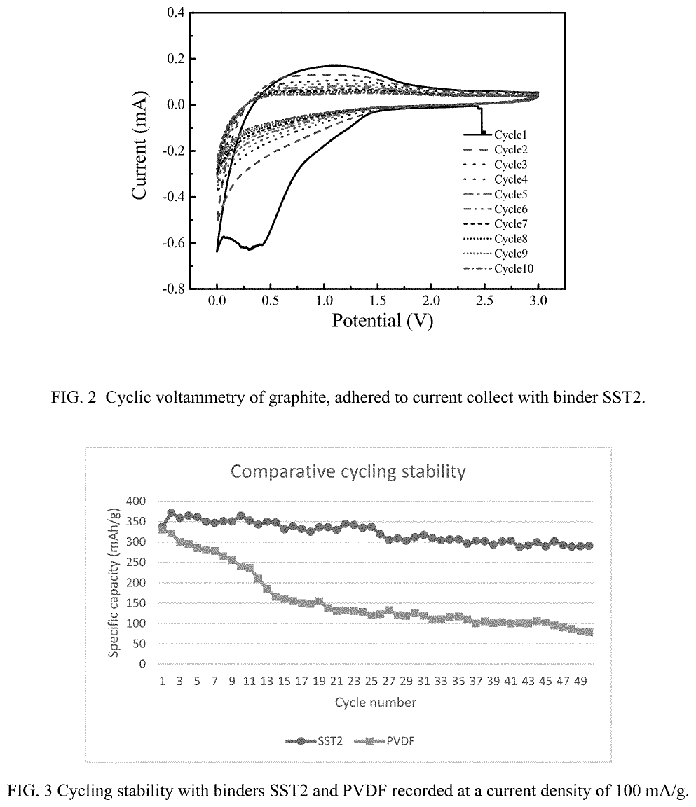

Cyclic Stability: A similar prototype was analyzed for cycling stability at constant current rate and compared against PVDF as binding agent. The data is shown in FIG. 3. The cyclic stability analysis was performed at 25° C. at 100 mA/g current density for 50 cycles. At the end of the 50 cycles, it was noted that in case of coin cell with SST2 as binding agent, the retention in specific capacity was 80% with respect to the specific capacity value of the first cycle. However, with PVDF as a binding agent, the electrode could retain around 22% of the specific capacity with respect to its initial specific capacity value. The retention in higher specific capacity by employing SST2 as a binding agent suggests that it can potentially retain the mechanical integrity of the electrode. This may be due to the presence of acrylic and siloxane moieties which offer strong electrostatic interactions and mechanical flexibility to retain the stability of the electrode during the cycling of the cell.

### Example 9: Silane Modified Polyurethane (SPUR) as a Binding Agent

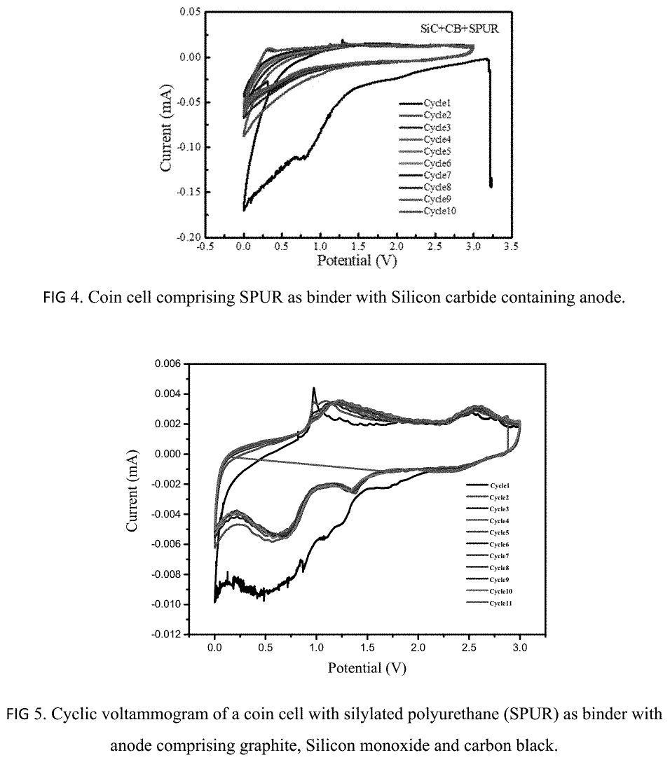

(I) Using Silicon carbide anode: Silylated polyurethane or SPUR was used as a binding agent in an electrode. In this example, silicon carbide (SiC) has been used as anode active material along with carbon black. The electrode comprised of SiC (70 wt %), carbon black (20 wt %) and SPUR (10 wt %), where SPUR was used as a binding agent. The CV was recorded, and the recorded spectra is presented in FIG. 4. The data shows that a SEI layer formed in the first cycle as noted from the trough in the first discharge cycle in presence of SPUR as a binding agent. Thereafter, a consistent and stable redox cycling is observed, suggesting that SPUR may develop a volume absorption matrix as a binding agent. This may also be due to the presence of soft polymeric segments present in the SPUR backbone which are capable to mitigate the volume expansion in the electrode active material.

(II) Using graphite, SiO and carbon black anode: In another example, SPUR (6 wt %) was used as a binding agent for the anode comprising graphite (77 wt %), SiO (13 wt %) and carbon black (4 wt %). The anode was cured by exposing it to humidity at room temperature for 6 h. The coin cell analysis showed that the electrochemical performance in presence of SPUR as binding agent is consistent for repeated cycling, which is shown in FIG. 5. The CV data (FIG. 5) showed the typical electrochemical response due to intercalation and deintercalation of lithium ions into the electrode active material. In the presence of SiO, SPUR showed consistent electrochemical response with continued cycling. This indicates appropriate compatibility between the surface of anode active material (such as SiO) and SPUR, which leads to retention in mechanical integrity of the electrode during cycling.

### Example 10: Siloxane Polyether as a Binding Agent

In another example, trisiloxane polyether (Silwet 408) was used as aqueous borne additives for a binding agent formulation. In this example, the electrochemical anode formulation comprised of graphite, silicon monoxide, carbon black as anode active materials, and SBR and trisiloxane polyether (such as Silwet 408 or S408) as binding agent additives.

For the comparative example, the control formulation was prepared including the binding agents SBR and CMC in a 2:1 ratio. The test formulation was prepared using SBR and trisiloxane polyether (Silwet 408) additives in a ratio of 2:1.

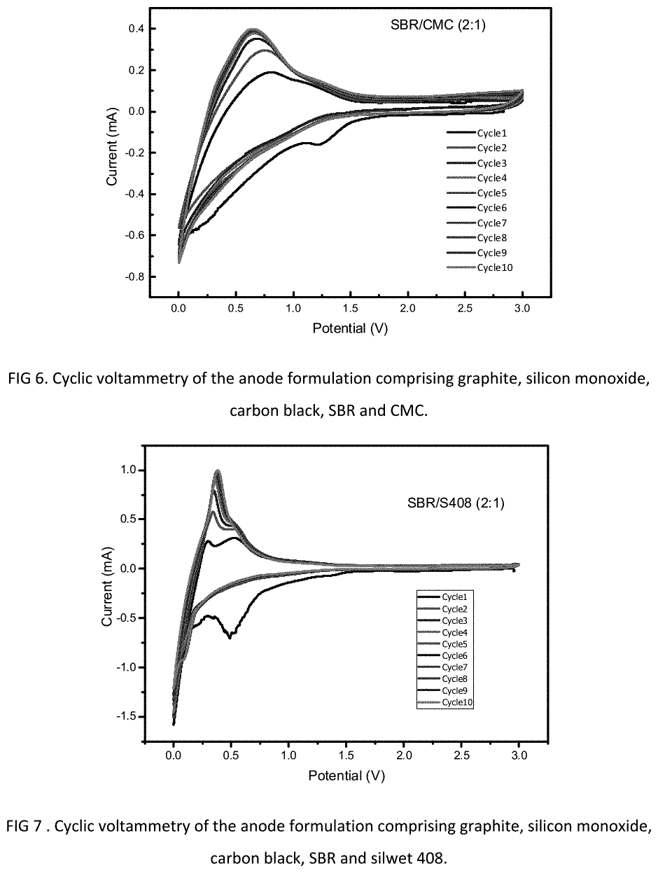

Control example—The CV data was recorded for both the control and test formulations for ten continuous cycles involving charge and discharge, which is presented in FIG. 6. The first discharge cycle for the SBR/CMC binding agent containing cell presents a peak at around 1.2 V followed by continuous decrement in the peak beyond 0.7 V. The peak at around 1.2 V may form due to the insertion of lithium ions between the planes of graphite, and the reduction of peak beyond 0.7 V may results due to the continuous insertion of Lithium ions into the basal planes and edges of the graphite. The corresponding oxidation peak suggests the extraction of lithium ion in the oxidation process.

Test example—Similar trends as shown in the control example above were noted in the subsequent cycles for coin cell containing SBR and Silwet 408 indicating the stability of the electrode. The coin cell containing Silwet 408 as co-binding agent showed a similar result as the control The data is presented in FIG. 7. In addition, no additional peaks were noted when the co-binding agent was changed from CMC to Silwet 408, indicating that Silwet 408 did not create any interference in the electrochemical processes. This study reveals the stability of the electrodes in the presence of CMC or Silwet 408 as co-binding agents with SBR. The continued cycles with unvaried CV behavior indicated that Silwet 408 could offer similar properties as CMC when added as co-binding agent.

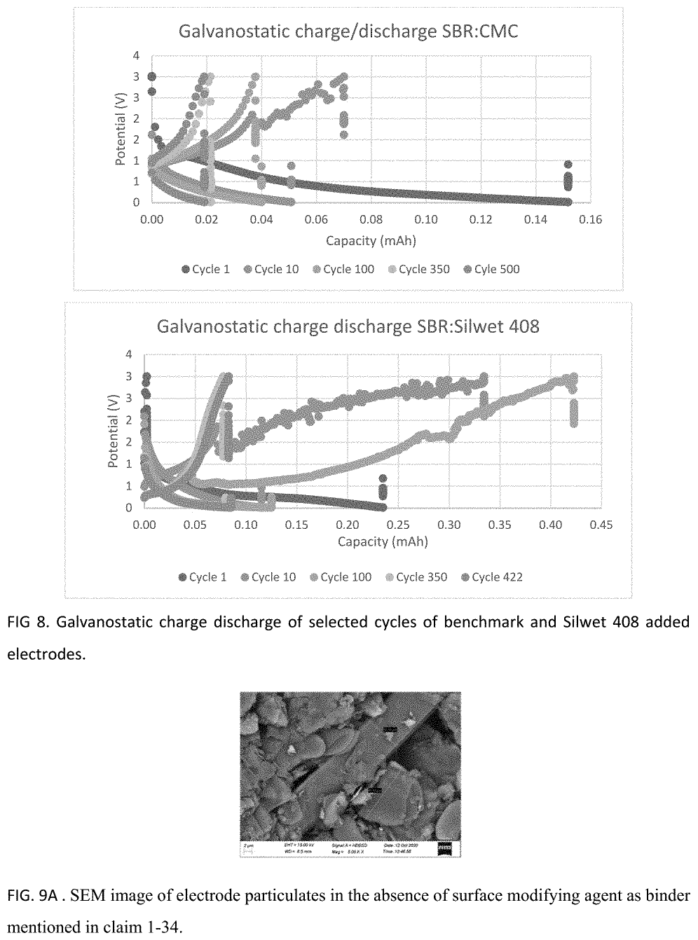

The cyclic stability of the cells were analyzed for 500 cycles at a constant current of 100 mA/g and the recorded observations of galvanostatic charge-discharged are shown in FIG. 8.

### Example 11: Graphite/SiO as Anode Material

Control experiment: The electrode constitutes graphite, silicon monoxide (SiO), and carbon black in the ratio of 77/13/6 in weight percent. In the control sample electrode, a SBR-CMC (2:1) mixture was used as a binding agent. The galvanostatic charge-discharge performance at a constant current density of 100 mA/g showed that the initial cycle delivered a specific capacity of 687 mAh/g and this specific capacity reduced to 68 mAh/g after 500 cycles, suggesting a retention of only 10% specific capacity after 500 cycles with respect to the first cycle. At the 10th cycle, the specific capacity reduced to 199 mAh/g, which indicated a reduction in specific capacity by 70% at the tenth cycle. However, after the tenth cycle onwards the per unit charge/discharge efficiency was close to unity. The reduction in the specific capacity over the number of cycles may be due to the loss in mechanical integrity of the electrode for repeated swelling, may be due to the presence of silicon monoxide in the active material composition. This suggests that the volume expansion experienced by graphite/SiO anodes during cycling was not mitigated by the SBR-CMC binding agent formulation.

Test experiment: In test experiment, trisiloxane polyether (Commercially available as Silwet 408) was added to the same anode material combination as mentioned in the control experiment above instead of CMC as a binding agent.

The electrodes including graphite, silicon monoxide (SiO), and carbon black were used in combination with SBR/Silwet 408. The initial specific capacity was noted to be 836 mAh/g at a current density of 100 mA/g which was higher compared to the electrode of control sample (above). In addition, the retention capacity after 500 cycles was noted to be 38%, which is significantly higher compared to the electrode of the control sample. Further, the per cycle efficiency was close to unity after the tenth cycle onwards. Application of trisiloxane polyether (Silwet 408) instead of CMC in the same anode material combination as binding agent results enhanced stability of the electrode

This invention provides a surface modifying composition that significantly alters the structural attributes of an electrochemical separator in an electrochemical cell for Lithium ion secondary batteries. Not only does the surface modifying agent successfully enhances the dimensional stability of the separator substrate by making it resistant to shrinkage (to the extent of 10% or less), as well as to curling at the edges, it remarkably enhances the electrolyte uptake of the separator substrate. Consequently, performance and safety attributes of the electrochemical cell is considerably improved. Further, the surface modifying agent of the present invention modifies the electrode particulates resulting in particulate aggregates. Such particulate aggregates display enhancement in capacity retention of the electrode. In other words, the surface modifying agent of the present invention has a significant influence on the performance, and safety attributes, of an electrochemical cell for lithium ion batteries, that is hitherto unknown.

Embodiments of the present technology have been described above and modification and alterations may occur to others upon the reading and understanding of this specification. The claims as follows are intended to include all modifications and alterations insofar as they come within

What is claimed is:

1. A surface modifying composition comprising: one or more surface modifying agents represented by Formula 1:
(R)ₐ(W)_{b}(R)_{a″} Formula 1
wherein a, a″ or b is zero or an integer greater than zero, with the proviso that (a+a″+b) is always greater than 0,
R is represented by Formula (1a) which is linear or branched:
(CH₂)_{c}(CH₂O)_{d}(CHOH)ₑ(X)_{g} Formula (1a)
X is independently a group represented by Formula (1b): 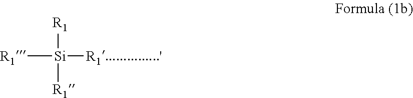
where R₁, R₁′, and R₁″ are each independently a hydrogen or C₁-C₂₀ alkyl radical, C₁-C₂₀ alkoxy radical, a C₆-C₂₀ aromatic radical, a hydroxyl radical, a hydrogen radical, a C₁-C₂₀ unsubstituted or substituted hydrocarbon, a C₁-C₂₀ fluorinated hydrocarbon, an ether, a fluoroether, an alkylene, a cycloalkylene, an arylene alkylene, a monovalent cyclic or acyclic, a methacrylate, a substituted or un-substituted carboxylate radical or epoxy radical, a C₁-C₁₀ carbonate or carbonate ester, c, d, e, and g are each independently zero or an integer greater than zero with the proviso that c+d+e+g>0,
W is a group represented by Formula (1c)
(Y)ₕ(Z)ᵢ Formula (1c)
wherein h and i are each independently zero or an integer greater than zero with the proviso that h+i>0,
Y in formula (1c) is a group represented by Formula (1d):
(M₁)_{x″}(D₁)ⱼ(D₂)ₖ((T₁)_{m′}(Q₁)_{n′}(M₂)_{y″} Formula (1d)
wherein j, k, l, m′, n′, x″, and y″ are each independently zero or an integer greater than zero with the proviso that (j+k+m′+n′+x″+y″)>0.
wherein M₁ is a group represented by Formula (1e):
R₂R₃R₄SiI_{1/2} Formula (1e)
D₁ is a group represented by Formula (1f):
R₅R₆SiI_{2/2} Formula (1f)
D₂ is a group represented by Formula (1g):
R₇R₈SiI_{2/2} Formula (1g)
Tᵢ is a group represented by Formula (1h):
R₉SiI_{3/2} Formula (1h)
Q₁ is a group represented by Formula (1i):
SiI_{4/2} Formula (1i)
M₂ is a group represented by Formula (1j):
R₁₀R₁₁R₁₂SiI_{1/2} Formula (1j)
R₂-R₁₂ are each independently R, R₁, R_{1′}, or R_{1″},
I is O or a CH₂ group with the proviso that the molecule contains an even number of O_{1/2} and even number of (CH₂)_{1/2},
Z in Formula (1c) is independently urethane, urea, anhydride, amide, imide, hydrogen radical, or a monovalent cyclic or acyclic, aliphatic or aromatic, substituted or un-substituted hydrocarbon, or a fluorinated hydrocarbon having 1-20 carbon atoms;
wherein the surface modifying agents, when in contact with a surface of an electrochemical substrate, modify the surface of the substrate.

2. The surface modifying composition of claim 1, wherein the composition comprises two parts,
a first part, wherein W of the formula 1 is represented by the formula:
(Y₁)ₕ(Z₁)ᵢ Formula (1k); and
a second part, wherein W of the formula 1 is represented by the formula:
(Y₂)ₕ(Z₂)ᵢ Formula (1l)
wherein Y₁ is represented by
(M₁)_{x″}(D₁)ⱼ(D₂)ₖ(M₂)_{y″} (1k′)
wherein M₁ is R₂R₃R₄SiI_{1/2};
D₁ is R₅R₆SiI_{2/2};
D₂ is R₇R₈SiI_{2/2}; and
M₂ is R₁₀R₁₁R₁₂SiI_{1/2};
where R₂ and R₁₂ are each independently selected from an alkene radical; R₃-R₈ and R₁₀-R₁₁ are each independently selected from a C1-C20 alkyl radical; a C1-C20 substituted or unsubstituted hydrocarbon; and
wherein Y₂ is represented by
(M₁)_{x″}(D₁)ⱼ(D₂)ₖ(M₂)_{y″} (1l′)
where M₁ is R₂R₃R₄SiI_{1/2};
D₁ is R₅R₆SiI_{2/2};
D₂ is R₇R₈SiI_{2/2}; and
M₂ is R₁₀R₁₁R₁₂SiI_{1/2};
wherein R₂, R₃, R₄, R₅, R₆, R₇, R₈, R₁₀, R₁₁, R₁₂ are each independently selected from C1-C20 alkyl radical, substituted alkyl radical, or hydrogen;
wherein at least one of R₂-R₈ and R₁₁-R₁₂ groups is hydrogen; and
Z₁ and Z₂ are independently selected from Z.

3. The composition of claim 2, wherein the R₂ and R₁₂ are in terminal positions and are each independently a C1-C20 alkene radical containing a fluorine atom.

4. The composition of claim 2, wherein Y₁ is represented by: 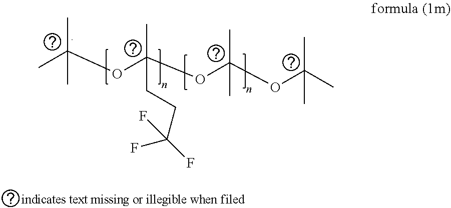
wherein n is an integer in the range from 1 to 1000.

5. The composition of claim 2, wherein the Y₂ is represented by: 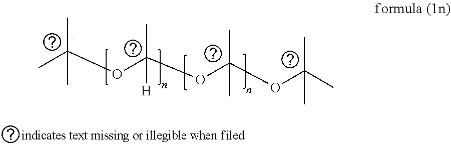
wherein n is an integer in the range from 1 to 1000.

6. The composition of claim 2, wherein R₂ and R₁₂ are in terminal positions and are each C1-C20 carbonate.

7. The composition of claim 1, wherein the surface modifying agent is represented by: 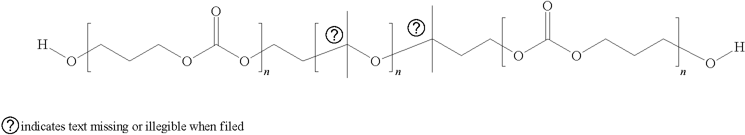
where n is an integer in the range from 1 to 1000.

8. The composition of claim 1, wherein W of formula 1 is represented by:
(M₁)_{x″} Formula (1d′)
wherein x″>0, and
wherein M₁ is a group represented by Formula (1e):
R₂R₃R₄SiI_{1/2} Formula (1e)
where one or more of the R₂-R₄ groups is a polyalkylene oxide functional group;
where I is O with the proviso that the molecule contains an even number of O_{1/2}.

9. The composition of claim 1, wherein one or more of R₂ to R₁₂ of M₁, M₂, D₁ D₂, or T is a polyalkylene oxide group.

10. The composition of claim 1, wherein the surface modifying agent is represented by formula: 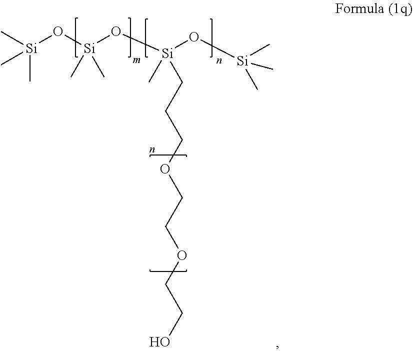
where m, n are integers in the range from 1 to 500.

11. The composition of claim 1, wherein Z of formula (1c) is a urethane and where Y, i and h have the meaning as assigned in claim 1.

12. The composition of claim 1, wherein Y of formula (1c) is a siloxane represented by:
(T₁)ₘ Formula (1d″)
wherein m is 1 or an integer greater than 1, and T₁ is a group represented by Formula (1h):
R₉SiI_{3/2} Formula (1h)
where R₉ is R, R₁, R_{1′}, or R_{1″} where R, R1, R1′ or R_{1″} are groups having the meaning as assigned in claim 1, and
where I is O, with the proviso that the molecule contains an even number of O_{1/2}.

13. The composition of claim 12, wherein R₉ is C₁-C₂₀ alkoxy radical, a C₁-C₂₀ alkyl radical, or a combination thereof.

14. The composition of claim 12, wherein R₉ is an ether group —O—(CH₂)_{b′}CH₃ where b′ is 0-10.

15. The composition of claim 12, wherein the surface modifying agent has a ladder configuration, or a cage configuration.

16. The composition of claim 12, wherein the surface modifying agent has a ladder configuration represented by: 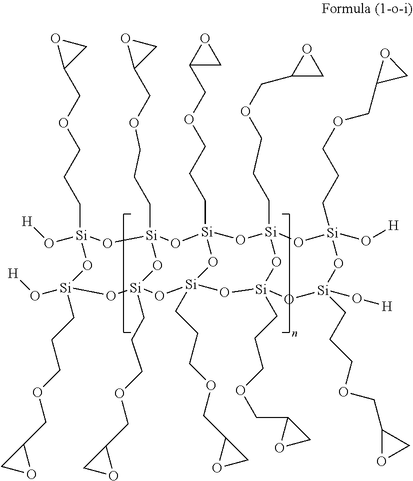
where n is an integer in the range from 1 to 500;
a ladder configuration represented by: 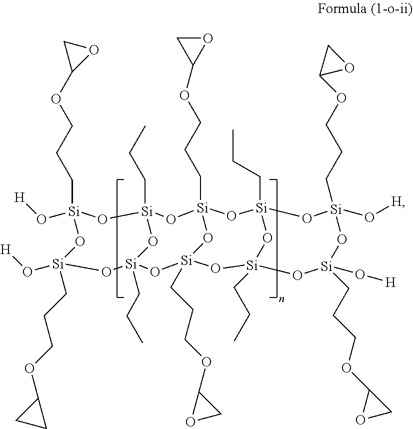
where n is an integer in the range from 1 to 500;
a ladder configuration represented by: 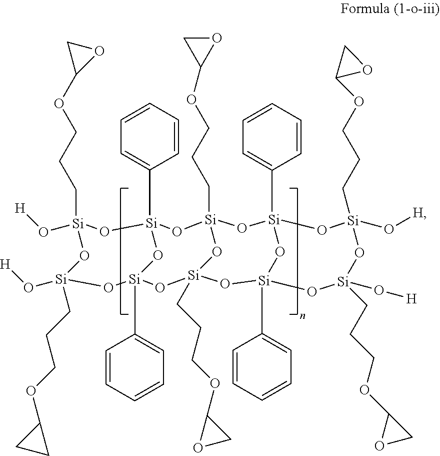
where n is an integer in the range from 1 to 500;
a ladder configuration represented by: 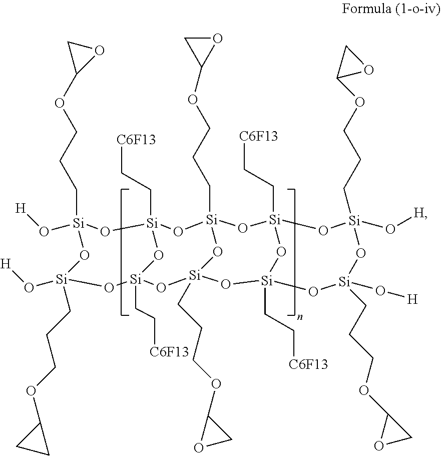
where n is an integer in the range from 1 to 500.
a ladder configuration represented by: 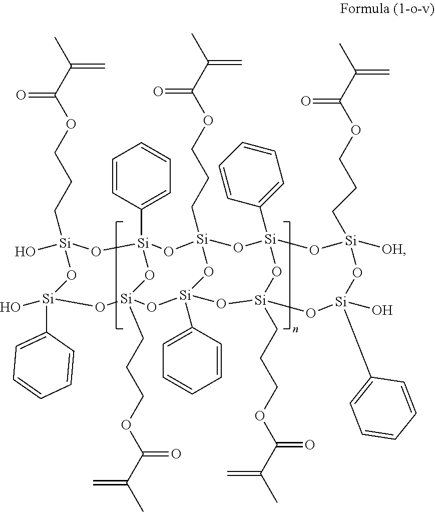
where n is an integer in the range from 1 to 500;
a ladder configuration represented by: 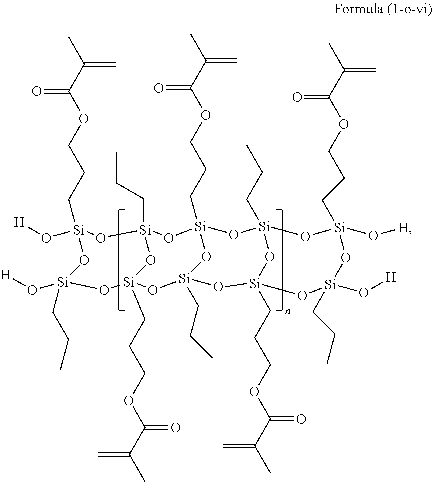
where n is an integer in the range from 1 to 500.
a ladder configuration represented by: 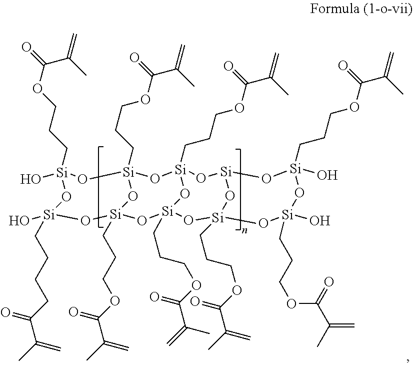
where n is an integer in the range from 1 to 500;
a ladder configuration represented by: 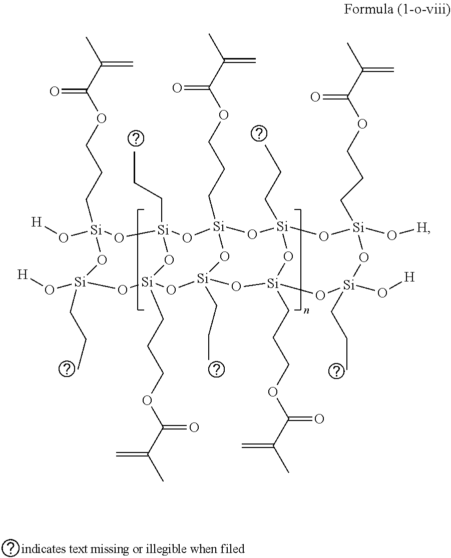
where n is an integer in the range from 1 to 500;
a ladder configuration represented by: 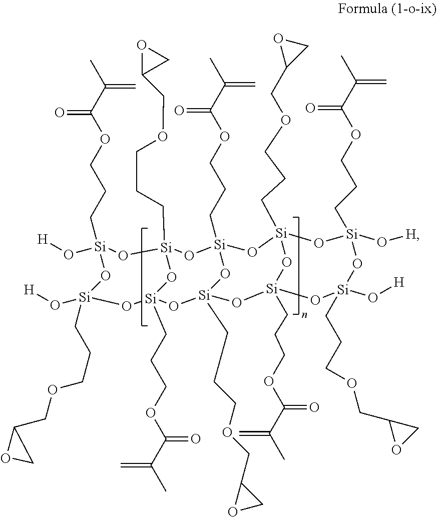
where n is an integer in the range from 1 to 500; and/or
a cage configuration represented by: 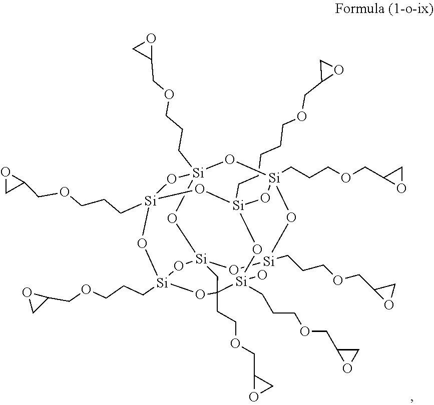
where n is an integer in the range from 1 to 500.

17. The composition of claim 1, wherein the surface modifying agent is present in an amount from about 0.1 wt. % to about 10 wt. %.

18. The composition of claim 1, wherein in formula 1, a is 1 when a″ is 0; or a is 0 when a″ is 1 with the proviso that b is 0, the surface modifying agent is represented by: 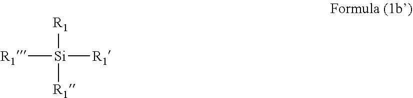
where R₁, R₁′, R₁″, and R₁″′ are each independently a hydrogen or a C₁-C₂₀ alkyl radical, a C₁-C₂₀ alkoxy radical, a C₆-C₂₀ aromatic radical, a hydroxyl radical, a hydrogen radical, a C₁-C₂₀ unsubstituted or substituted hydrocarbon, a C₁-C₂₀ fluorinated hydrocarbon, an ether, a fluoroether, an alkylene, a cycloalkylene, an arylene alkylene, a monovalent cyclic or acyclic, a methacrylate, a substituted or un-substituted carboxylate radical or epoxy radical, a C₁-C₁₀ carbonate or carbonate ester.

19. The composition of claim 1, wherein the electrochemical substrate is an electrode, a separator, a binding agent, an electrode active material, or a combination thereof.

20. The composition of claim 1, wherein the surface modifying agent modifies the surface of the substrate by formation of a film.

21. The composition of claim 1, wherein the surface modifying agent modifies the surface of the substrate by formation of a coating.

22. The composition of claim 1, wherein the surface modifying agent modifies the surface of the substrate by binding particles to the substrate.

23. The composition of claim 1, wherein the electrochemical substrate is disposed in a non-aqueous secondary battery.

24. A coated electrochemical substrate comprising the surface modifying agent of claim 1.

25. The coated electrochemical substrate of claim 24, wherein the substrate has a shrinkage of less than about 10%. when heated at a temperature of 200° C. for 3 min.

26. The coated electrochemical substrate of claim 24, wherein the substrate has an electrolyte uptake of more than 100% at a temperature of 25° C. with reference to the uncoated polypropylene substrate.

27. Electrode particulate-aggregates comprising the surface modifying agent of claim 1.

28. The electrode particulate aggregates of claim 27 having retention of specific capacity of at least 38% after 500 cycles and at a current density of 100 mA/g.

29. A process for preparing a surface modifying composition, the process comprising: contacting the one or more surface modifying agents of claim 1 with a solvent to prepare a slurry.

30. A process for preparing a surface-modified electrochemical substrate, the process comprising contacting the composition of claim 1 to an electrochemical substrate.

31. A surface modified electrochemical substrate prepared by the process of claim 30.

32. An electrochemical cell comprising the surface modified electrochemical substrate of claim 31.

33. The electrochemical cell of claim 32 wherein the surface modified electrochemical substrate is an electrode and/or a electrochemical separator.

34. Use of a surface modifying composition of claim 1 as a binding agent in an electrode for an electrochemical cell.

35. Use of a surface modifying composition of claim 1 as a coating for an electrochemical substrate.
